(19) United States
(12) Patent Application Publication
(10) Pub. No.: US 2009/0116365 A1
(43) Pub. Date: May 7, 2009

(54) Optical Recording Medium and Optical Recording Method

(75) Inventors: Kazunori Ito, Kanagawa (JP); Eiko Hibino, Kanagawa (JP); Mikiko Takada, Kanagawa (JP); Hiroshi Deguchi, Kanagawa (JP); Hiroko Ohkura, Kanagawa (JP); Hiroshi Miura, Kanagawa (JP)

Correspondence Address: DICKSTEIN SHAPIRO LLP, 1825 EYE STREET NW, Washington, DC, 20006-5403, US

(73) Assignee: Ricoh Company, Ltd., Ohta-ku, Tokyo (JP)

(21) Appl. No.: 11/887,389

(22) PCT Filed: Mar. 31, 2006
(86) PCT No.: PCT/JP2006/307388

§ 371 Date: Nov. 1, 2007

(30) Foreign Application Priority Data
Apr. 1, 2005 (JP) 2005-106637
Apr. 28, 2005 (JP) 2005-132324
Sep. 8, 2005 (JP) 2005-260346
Feb. 23, 2006 (JP) 2006-046623
Mar. 10, 2006 (JP) 2006-065606

(51) Int. Cl. G11B 7/00

(52) U.S. Cl. 369/116; 369/275.4; G9B/7

(57) ABSTRACT

An optical recording method to record information with a mark length recording method, where an amorphous mark and a crystal space are recorded only in the groove of a substrate having a guide groove, with the temporal length of the mark and the space of nT (T denotes a reference clock period; n denotes a natural number). The space is formed at least by an erase pulse of power Pₑ; all the marks of 4T or longer are formed by a multi pulse alternatively irradiating a heating pulse of power P_{w} and a cooling pulse of power P_{b} while P_{w}>P_{b}; and the Pₑ and the P_{w} satisfy the following relations:

0.15≦Pₑ/P_{w}≦0.4, and

0.4≦τ_{w}/(τ_{w}+τ_{b})≦0.8,

where τ_{w} denotes the sum of the length of the heating pulses, and τ_{b} denotes the sum of the length of the cooling pulses.

### TECHNICAL FIELD

The present invention relates to a high-density optical recording medium having a phase-change recording layer such as DVD+RW, DVD-RW, BD-RE, HD DVD RW and a recording method for the optical recording medium.

### BACKGROUND ART

The increase in the capacity of electric information has been prominent, and optical recording media which enable faster recording have been desired since a recording apparatus handling larger volume data requires more time for recording. In particular, the speeding up of disk-shaped optical recording media has been increasing since the rotational speed can increase the recording and reproducing speeds. Among such optical recording media, ones having a simple recording mechanism that recording takes place only with an intensity modulation of a light irradiated during recording have become popular since they enable the price reduction of the optical recording medium and recording apparatus. An optical recording medium for recording only in a groove has also become popular since it ensures high compatibility with an optical read-only apparatus.

In a conventional groove recording, as disclosed in Patent Literature 1 for example, a recording mark is formed such that the mark runs over the groove width in order to satisfy the modulation standard of DVD-ROM, ‘Modulation M≧0.6, where modulation M=(the maximum reflectivity−the minimum reflectivity)/the maximum reflectivity.’ In this example, the recording speed is 2.4× of the reference speed of DVD, where 2.4×-speed is approximately 8.4 m/sec. The scanning velocity of a beam is small with such low recording velocity, and a sufficient erase ratio may be obtained even when the width of a recording mark is larger than the groove width since the crystallization proceeds with the residual heat from the passed beam.

Among the optical discs which record only in a groove, optical recording media such as CD-RW, DVD+RW and DVD-RW have been put into practical use as optical recording media which employ a phase-change medium enabling re-writing, and an optical recording medium enabling a high-speed recording has been developed for each. Also, optical disc systems which enable a recording with larger capacity by means of a blue laser diode (LD) including Blu-ray Disc which allows a higher-volume recording have been put into practical use, and the speeding up of such optical disc systems is expected. Among such re-writable DVDs, DVD+RW has been standardized for up to 8×-speed (approximately 28 m/sec), DVD-RW for up to 6×-speed (approximately 21 m/sec), and Blu-ray Disc for up to 2×-speed (approximately 9.84 m/sec). Further development for speeding up has been awaited.

Until now, the speeding up of a phase-change optical recording medium has been achieved by applying a material having a high crystallization speed to a recording layer or increasing the crystallization speed in combination with a protective layer. However, it has become clear that the increase in the crystallization speed of an optical recording medium in response to the fast recording speed of DVD over 8×-speed causes various adverse effects as described below.

The first point is that a large crystal grows in an amorphous mark in the process of recording and that the apparent mark length is shorter, than intended, causing an error in reproducing. As shown in FIGS. 1A to 1C, an abnormal crystal growth occurs in a mark depending on the recording conditions when a recording is performed on an optical recording medium with high crystallization speed. It has been known that the abnormal crystal growth causes a distortion in the reproducing signal and enhances the error. Here, FIG. 1A is a schematic diagram illustrating the abnormal re-crystallization region; A and C represent normal marks while B is a mark having an abnormal re-crystallization region. Also, FIG. 1B shows reproducing signals of the marks A to C, and FIG. 1C shows reproducing signals of the marks A to C after binarization. This error tends to increase as the recordable speed increases. A possible countermeasure to this problem is to resolve the problem in the lower-speed region without largely increasing the crystallization speed in the recording layer and to develop a recording method which improves the recording characteristics in the higher-speed region.

However, it is easily inferred from the principle of the phase-change recording that a high-speed recording at a low crystallization speed suppresses the speed of the crystal growth during the formation of a recording mark and widens the recording mark as an amorphous layer and that the above-mentioned problem occurs. Therefore, it has been considered difficult to achieve the both high-speed recording and wide range of recordable speed.

Also, Patent Literature 2 discloses an example as an attempt to achieve sufficient re-writing performance with a wide range of recording speed by varying the time constant of the write strategy. In this case, the attempt is by means of widening a recording mark. In addition, in a method disclosed in Patent Literature 3, overwriting becomes difficult at a higher speed, and there is a problem that the range of recording speed is inadequate.

The second point is a so-called cross light in which a recorded amorphous mark is partially re-crystallized by recording in an adjacent track. An optical recording medium with a high crystallization speed is prone to re-crystallization; therefore, a sufficient melting region should be allocated so that an amorphous mark with an adequate size may be recorded even with re-crystallization. In this regard, the power of LD should be enhanced, and there is a problem that the LD tends to heat unnecessarily an adjacent track and crystallizes a part of the recorded amorphous mark.

The third point is the problem that a low-speed recording with recording conditions equivalent to a conventional low-speed optical recording medium is not possible. In other words, the backward compatibility cannot be maintained. Even though a recording over 8×-speed is achieved for DVD, it is a problem that the convenience of a user is sacrificed unless the recording is possible with a conventional drive for 8×-speed recording.

An optical disc system for higher-speed recording which does not have the problems of increase in errors due to abnormal re-crystallization and increase in jitter due to cross light and which maintains the backward compatibility that a recording in the same optical recording medium at a low speed is maintained even with a conventional drive for low-speed recording has not been achieved. Currently, a prompt supply of such optical disc system has been desired.

In general, a crystal phase with high reflectivity is considered as a non-recorded state, and a mark composed of an amorphous phase with low reflectivity and a space composed of a crystal phase with high reflectivity are formed by means of intensity modulation of an applied laser beam, and information is recorded on an optical disc with a phase-change recording material.

FIG. 2 shows an example of an irradiation pattern of a laser beam in recording. A mark composed of an amorphous phase is formed by pulse irradiation of repetitive and alternating peak power (Pₚ=P_{w}) and bias power (P_{b}). A space composed of a crystal phase is formed by continuous irradiation of erase power (Pₑ) which has the intermediate intensity of the above powers. When a pulse train consisting of a peak power and a bias power is irradiated, melting and quenching are repeated in a recording layer, and an amorphous mark is formed. When an erase power is irradiated, the recording layer is melted and then annealed or annealed while maintaining its state as a solid for crystallization, and a space is formed.

FIG. 2 is an example of a 1T write strategy in which the period of a pulse forming an amorphous mark is 1T (T represents a reference clock period). A 2T write strategy is used for higher-speed recordings in which the pulse period is 2T.

As stated above, it is necessary to melt the recording layer once in order to form an amorphous mark. Since the time for irradiating the peak power is shortened in a high-speed recording, a higher power is required. However, a favorable mark may not be formed due to insufficient power since the laser diode (LD) has a limitation in its output power. Therefore, a lower melting point is desired for a recording layer material for a high-speed recording.

Various phase-change recording materials satisfying the above requirement have been proposed. Among those, Ag—In—Sb—Te material is known as a material with superior re-writing performance and widely used for CD-RW and DVD+RW.

An Ag—In—Sb—Tb material is made by introducing Ag and In to an Sb—Teδ phase as a solid solution of an Sb—Te binary system containing 63% by atom to 83% by atom of Sb. An Sb—Teδ system with various additional elements generally enables to increase the crystallization speed by increasing the composition ratio of Sb and hence to correspond to a high-speed recording.

A disadvantage of such Sb—Teδ phase is that it has a low crystallization temperature of 120° C. to 130° C. Therefore, it is necessary to introduce elements such as Ag, In and Ge to increase the crystallization temperature to 160° C. to 180° C. to improve the stability of an amorphous mark. This enables the formation of a recording layer which is suitable for a high-speed DVD recording at up to about 4×-speed.

For further speeding up such as high-speed recording equivalent to 8×-speed of DVD or faster, it is necessary to increase the composition of Sb to improve the crystallization speed. However, increasing the composition of Sb tends to make the initialization difficult, causing non-uniformity in reflectivity after initialization. This increases the noise, and a favorable recording with low jitter cannot be achieved. Also, the increase of Sb further reduces the crystallization temperature, so it cannot help but increase the quantity of additives. The simple increase of additives also makes the initialization difficult, causing the increase in the noise, and a favorable recording with low jitter cannot be achieved. In other words, it is difficult to obtain a recording layer with an Sb—Teδ system that satisfies a crystallization speed for high-speed recording equivalent to 8×-speed of DVD, simple initialization and preservation stability of an amorphous mark.

Given this factor, materials such as Ga—Sb system and Ge—Sb system having Sb as a main component with additional elements which promote the amorphousness have been proposed as an alternative to Sb—Teδ phase with higher crystallization speed and superior stability of amorphous mark. Ga—Sb and Ge—Sb both have a eutectic point where Sb-rich composition with the composition of Sb exceeding 80% by atom, and these materials with a composition near their eutectic points can be used as high-speed recording materials. Similarly to Sb—Teδ phase system, the increase in the Sb composition can accelerate the crystallization. Since the crystallization is high around 180° C., the stability of an amorphous mark is superior without an addition of other elements.

However, these eutectic points are around 590° C., which is higher than the eutectic point of Sb—Teδ phase system of 550° C., and the recording power may be insufficient. Also, according to examinations by the inventors of the present invention, materials with high melting points are prone to non-uniformity of reflectivity after initialization. Therefore, the noise is also increased after initialization after all, and a favorable recording with low jitter is difficult. The reason is not clear, but it cannot be resolved simply by the increase in the initialization power. Thus, a lower melting point is advantageous.

The inventors of the present invention examined an In—Sb system having a low eutectic point of about 490° C. with the Sb composition of 68% by atom and found that this In—Sb system was a material with a high crystallization speed with little non-uniformity of reflectivity after initialization and with superior stability of an amorphous mark. However, further researches revealed that this In—Sb system had a disadvantage of low crystallization stability despite its superior stability of an amorphous phase.

For example, the oscillographs in FIGS. 3A and 3B show the decrease in the reflectivity of a non-recorded portion (crystal portion) of an In—Sb alloy having a composition close to its eutectic composition before (FIG. 3A) and after (FIG. 3B) of a preservation test at a temperature of 80° C. for 100 hours. The results of the preservation test indicate that the reflectivity decreases by 10% or greater, and there is a risk that the medium does not satisfy the standards. In addition, a recording in a condition with reduced reflectivity results in severely degraded jitter, and a favorable recording cannot be performed.

On the other hand, Patent Literature 4 proposes, in regard to the In—Sb system, an alloy having a composition expressed as:

(In₁₀₀₋ₓSbₓ)_{100-y}M_{y}

where x and y denote % by atom; x is 40% by atom to 80% by atom, and 0% by atom <y≦30% by atom.

Examples of the element expressed as M in this alloy are Zn, Cd, Tl, Pb, Po, Li and Hg.

Also, Patent Literature 5 proposes the use of a microcrystal as a recording thin-layer consisting of 20% by atom to 60% by atom of In and 40% by atom to 80% by atom of Sb. Furthermore, as an element to be added to the recording thin layer, Al, Si, P, S, Zn, Ga, Ge, As, Se, Ag, Cd, Sn, Te, Ti, Pb and Bi are given.

Also, Patent Literature 6 proposes the use of an alloy having a composition expressed as:

In₅₀₋ₓSb₅₀₋ₓM₂ₓ

where 0% by atom <x≦5% by atom.

Examples of the element expressed as M in this alloy are Bi, Cd, P, Sn, Zn and Se, and the composition ratio of In to Sb is restricted to 1/1.

Also, Patent Literature 7 proposes the use of an alloy as a recording layer having a composition expressed as:

(M₁₀₀₋ₓSbₓ)_{100-y}In_{y}

where x and y denote % by atom; x is 20% by atom to 80% by atom, and y is 2% by atom to 50% by atom.

Examples of the element expressed as M in this alloy are Zn, Cd, Hg, Yl, Pb, P, As, B, C and S. The quantity of M is large, and with the smallest quantity of M, i.e. x=20% by atom and y=50% by atom, the composition of Sb is 40% by atom, and the composition of In is 50% by atom.

Also, Patent Literature 8 proposes the use of a crystallization layer of an alloy as a recording layer having a composition expressed as:

(In₁₀₀₋ₓSbₓ)_{100-y}M_{y}

where x and y denote % by atom; 50% by atom ≦x≦70% by atom, and 0% by atom ≦y≦20% by atom.

Examples of the element expressed as M in this alloy are Al, Si, P, Zn, Ga, Ge, As, Se, Ag, Cd, Sn, Te, Tl, Bi, Pb, Mo, Ti, W, Au, P and Pt. In the above composition formula, the ratio of In is 24% by atom to 70% by atom.

However, Patent Literatures 4 to 8 mentioned above are not considering an optical recording medium having a layer composition enabling to form an extremely small mark with a shortest mark length of 0.4 μm or less for the current DVD, considering the technical level in the 1980s, around when these applications were filed, i.e. 1984 to 1987. They of course do not consider the compliance to a high-speed recording of DVD and Blu-ray Disc, and they neither disclose nor indicate any specific detail.

Patent Literature 1: Japanese Patent Application Laid-Open (JP-A) No. 2002-237096

Patent Literature 2: JP-A No. 2003-16643

Patent Literature 3: Japanese Patent (JP-B) No. 3572068

Patent Literature 4: JP-A No. 63-79242

Patent Literature 5: Japanese Patent Publication (JP-B) No. 04-1933

Patent Literature 6: JP-A No. 63-206922

Patent Literature 7: JP-A No. 63-66742

Patent Literature 8: JP-A No. 63-155440

### DISCLOSURE OF INVENTION

The present invention is aimed at providing an optical recording medium and an optical recording method which can achieve an optical disc system which can perform a high-speed recording, wherein the optical disc system can perform a recording without problems such as error increase due to abnormal re-crystallization and jitter increase due to cross light, and a high-speed recording is possible while maintaining a backward compatibility such that a low-speed recording can be performed on the same optical recording medium in a drive for low-speed recording.

In addition, the present invention provides an optical recording medium for a high-density recording, where the optical recording medium can comply with DVD at 8×-speed or faster or Blu-ray Disc at 4×-speed or faster, and the optical recording medium includes a phase-change recording layer which is superior in re-writing performance and provides stable amorphous and crystal phases and simple initialization.

The means for solving the above problems are as follows. That is:

<1> An optical recording method including the steps of:

irradiating a light on an optical recording medium including a substrate with a guide groove and at least a phase-change recording layer on the substrate, and
recording a mark of an amorphous phase and a space of a crystal phase on the phase-change recording layer, corresponding to any one of the salient portion or the depressed portion of the groove as viewed from the incoming direction of the light,

wherein information is recorded by means of a mark length recording method, and the temporal length of the mark and the space is expressed as nT,

wherein T denotes a reference clock period, and n denotes a natural number;

the space is formed at least by an erase pulse irradiating power Pₑ;

all the marks having a length of 4T or greater are formed by a multi pulse alternatively irradiating a heating pulse of power P_{w} and a cooling pulse of power P_{b} while P_{w}>P_{b}; and

the Pₑ and the P_{w} satisfy the following equations:

0.15≦Pₑ/P_{w}≦0.4, and

0.4≦τ_{w}/(τ_{w}+τ_{b})≦0.8,

wherein τ_{w} denotes the sum of the length of the heating pulses, and τ_{b} denotes the sum of the length of the cooling pulses.

<2> An optical recording method including the steps of:

irradiating a light on an optical recording medium having a substrate with a guide groove and at least a phase-change recording layer on the substrate, and
recording a mark of an amorphous phase and a space of a crystal phase on the phase-change recording layer, corresponding to any one of the salient portion or the depressed portion of the groove as viewed from the incoming direction of the light,

wherein information is recorded by means of a mark length recording method, and the temporal length of the mark and the space is expressed as nT,

wherein T denotes a reference clock period, and n denotes a natural number;

the space is formed at least by an erase pulse irradiating power Pₑ, and the mark is formed by irradiating a heating pulse of power P_{w}, while P_{w}>P_{b}; and

the Pₑ and the P_{w} satisfy the following equation: 0.15≦Pₑ/P_{w}≦0.5.

<3> The optical recording method according to any one of <1> and <2>,

wherein a recording is performed at 10×-speed of the reference speed or faster when a recording and reproducing is performed with a laser beam having a wavelength of 640 nm to 660 nm, and

a recording is performed at 4×-speed of the reference speed or faster when a recording and reproducing is performed with a laser beam having a wavelength of 400 nm to 410 nm.

<4> The optical recording method according to any one of <1> to <3>,

wherein a recording is performed such that the average of the minimum distance between marks on two adjacent tracks in the radial direction is greater than the half of the track pitch.

<5> The optical recording method according to any one of <1> to <4>,

wherein the modulation M of the longest mark satisfies the following equation: 0.35≦M≦0.60.

<6> An optical recording method including information regarding the optical recording method according to any one of <1> to <5> is recorded in advance on its substrate.

<7> An optical recording medium including a substrate with a guide groove and at least a phase-change recording layer on the substrate,

wherein the rotational linear velocity of the optical recording medium is a variable, and the transition linear velocity corresponding to the point at which the reflectivity measured by the irradiation of a continuous light with a pick-up head on the optical recording medium starts to decrease is 5 m/s to 35 m/s; and

the phase-change recording layer includes a phase-change material expressed by Composition Formula (1) below:

(Sb₁₀₀₋ₓInₓ)_{100-y}Zn_{y} Composition Formula (1)

wherein, in Composition Formula (1), x and y denote the percentage of respective elements by atom, 10% by atom ≦x≦27% by atom, and 1% by atom ≦y≦10% by atom.

<8> An optical recording medium including a substrate with a guide groove and at least a phase-change recording layer on the substrate,

wherein the rotational linear velocity of the optical recording medium is a variable, and the transition linear velocity corresponding to the point at which the reflectivity measured by the irradiation of a continuous light with a pick-up head on the optical recording medium starts to decrease is 5 m/s to 35 m/s, and

the phase-change recording layer includes a phase-change material expressed by Composition Formula (2) below:

[(Sb_{100-z}Sn_{z})₁₀₀₋ₓInₓ]_{100-y}Zn_{y} Composition Formula (2)

wherein, in Composition Formula (1), x, y and z denote the percentage of respective elements by atom, 0% by atom ≦z≦25% by atom, 10% by atom ≦x≦27% by atom, and 1% by atom ≦y≦10% by atom.

<9> The optical recording medium according to any one of <7> to <8>,

wherein the optical recording medium includes the substrate with a guide groove, a first protective layer, the phase-change recording layer, a second protective layer and a reflective layer in the order mentioned from the direction of the incoming light.

<10> The optical recording medium according to any one of <7> to <9>,

wherein the phase-change recording layer has a thickness of 6 nm to 22 nm.

<11> The optical recording medium according to any one of <9> to <10>,

wherein the optical recording medium includes an interfacial layer any one of between the phase-change recording layer and the first protective layer and between the phase-change recording layer and the second protective layer; and

the interfacial layer includes an oxide of any one of Ge and Si.

### BRIEF DESCRIPTION OF DRAWINGS

FIG. 1A is a schematic diagram illustrating an abnormal crystal growth occurred in recording a mark, which causes a distortion in a reproducing signal and amplifies an error.

FIG. 1B is a diagram showing the reproducing signals of marks A to C.

FIG. 1C is a diagram showing the reproducing signals of marks A to C after binarization.

FIG. 2 is a diagram showing a 1T write strategy in which the period of a pulse forming an amorphous mark is 1T, where T denotes a reference clock period.

FIG. 3A is an oscillograph of an In—Sb alloy having a composition close to its eutectic composition prior to a preservation test.

FIG. 3B is an oscillograph of an In—Sb alloy having a composition close to its eutectic composition after a preservation test at a temperature of 80° C. for 100 hours.

FIG. 4 is a diagram illustrating a transition linear velocity.

FIG. 5 is a TEM photograph of an optical recording medium compatible with 8×-speed recording on which a recording has been performed such that the modulation M is 0.63.

FIG. 6 is a TEM photograph of an optical recording medium on which a recording has been performed such that A(Lᵣₘ)≧1/2·Lₜₚ.

FIG. 7A is a diagram showing an example of a 1T write strategy for rewriting data consisting of marks and spaces.

FIG. 7B is a diagram showing the condition of the pulse emission of FIG. 7A.

FIG. 8 is a diagram showing an example of a 2T write strategy.

FIG. 9A is a diagram showing an example of a write strategy and the relation between the re-crystallization region and an amorphous mark with a small value of Σ_{w}/(τ_{w}+τ_{b}), where for each mark length having a length of 4T or greater, τ_{w} denotes the sum of the irradiation period of the heating pulse P_{w}, τ_{b} denotes the sum of the irradiation period of the heating pulse P_{w}, and the value of τ_{w}/(τ_{w}+τ_{b}) is varied.

FIG. 9B is a diagram showing the case with a large value of τ_{w}/(τ_{w}+τ_{b}).

FIG. 10 is a diagram showing an example of a block write strategy.

FIG. 11A is a schematic diagram showing the relation between the re-crystallization region and an amorphous mark when a recording is performed with a write strategy of FIG. 10 and showing the state in which a teardrop mark is formed.

FIG. 11B is a schematic diagram showing the relation between the re-crystallization region and an amorphous mark when a recording is performed with a write strategy of FIG. 10 and showing the state in which a mark in a favorable shape is obtained even with a long pulse.

FIG. 12 is a diagram showing an example of a block write strategy of the present invention.

FIG. 13 is a diagram showing another example of a block write strategy of the present invention.

FIG. 14 is a diagram showing yet another example of a block write strategy of the present invention.

FIG. 15 is a diagram showing yet another example of a block write strategy of the present invention.

FIG. 16 is a schematic diagram showing an example of an optical recording medium of the present invention, illustrating a DVD+RW, a DVD-RW and a HD DVD RW.

FIG. 17 is a schematic diagram showing an example of an optical recording medium of the present invention, illustrating a Blu-ray Disc.

FIG. 18 is a diagram showing results of evaluating the error rate in reproducing, with a 2T write strategy, a recording speed of 6×-speed and the modulation adjusted by varying a recording power.

FIG. 19 is a diagram showing the relation between τ_{w}/(τ_{w}+τ_{b}) and jitter σ/T_{w} after 10 re-writings in Example A-19, where τ_{w} denotes the sum of the length of the heating pulses, and b denotes the sum of the length of the heating pulses.

FIG. 20 is a diagram showing the values of jitter when the lowest value of jitter was obtained after 10 re-writings in Example A-21.

FIG. 21 is a diagram showing the relation between jitter and modulation in Example A-24 and Comparative Examples A-14 to A-15.

FIG. 22 is a diagram showing the relation between jitter and modulation in Example A-24 and Comparative Examples A-14 to A-15.

FIG. 23 is a graph showing the relation between Sb/(In+Sb) and the decreased reflectivity (Δ%).

FIG. 24 is a diagram showing a write strategy without a cooling pulse in the mark formation process used in Example B-14.

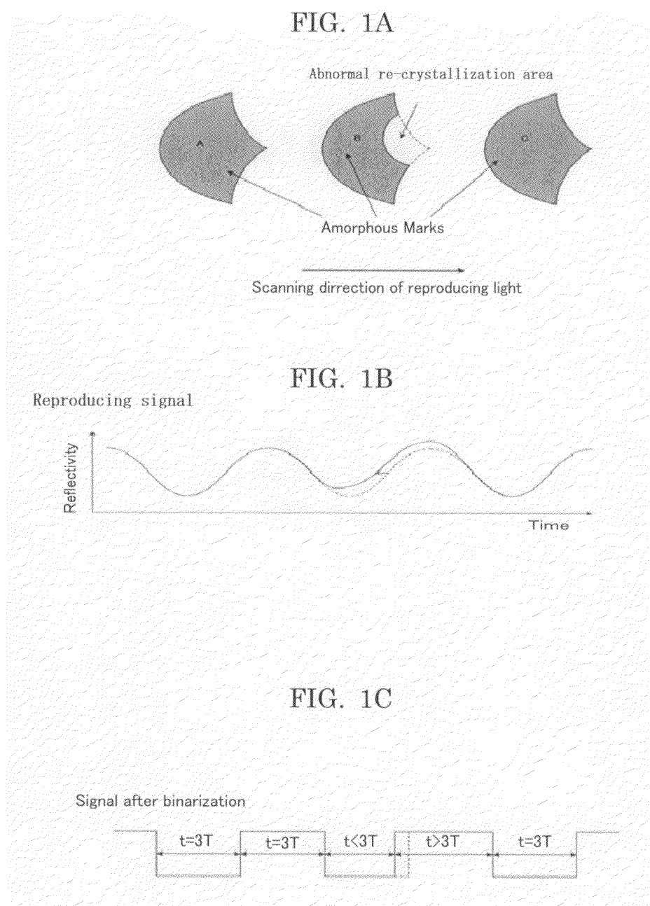

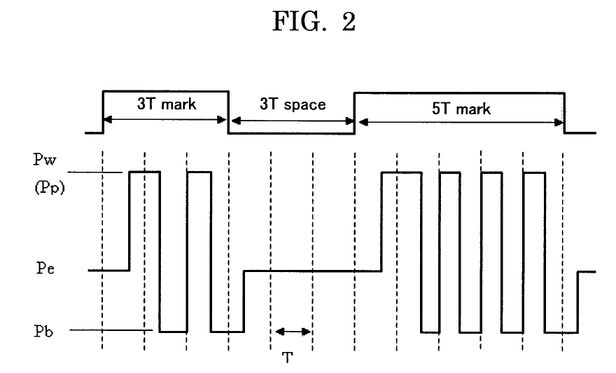

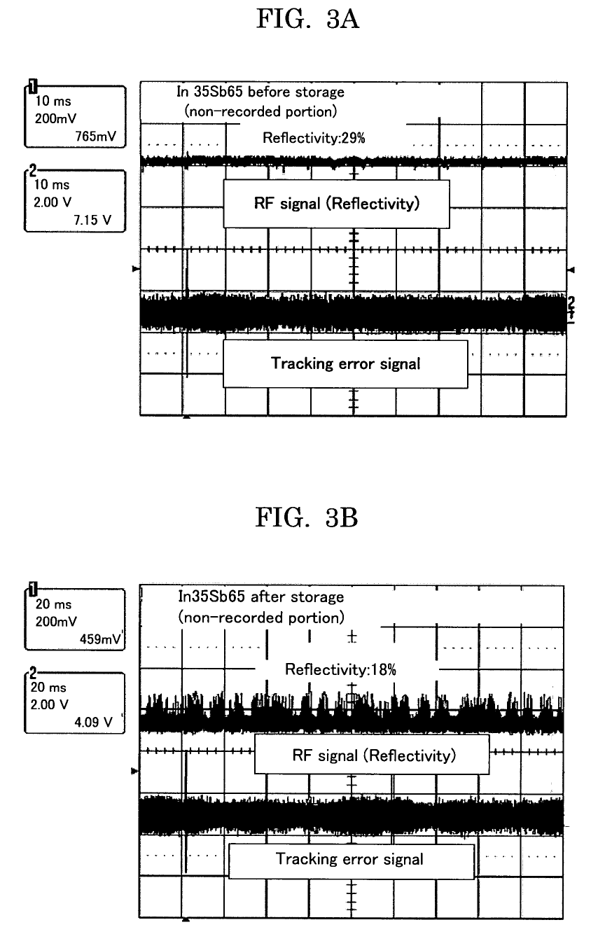

### BEST MODE FOR CARRYING OUT THE INVENTION

### Optical Recording Method

An optical recording method of the present invention irradiates a light on an optical recording medium including a substrate with a guide groove and at least a phase-change recording layer on the substrate and records a mark of an amorphous phase and a space of a crystal phase on the phase-change recording layer, corresponding to any one of the salient portion or the depressed portion of the groove as viewed from the incoming direction of the light, and information is recorded by means of a mark length recording method, and the temporal length of the mark and the space is expressed as nT, where T denotes a reference clock period, and n denotes a natural number.

In the first aspect, the space is formed at least by an erase pulse of power Pₑ,

all the marks having a length of 4T or greater are formed by a multi pulse which alternatively irradiates a heating pulse of power P_{w} and a cooling pulse of power P_{b} while P_{w}>P_{b}, and

the Pₑ and the P_{w} satisfy the following equations:

0.15≦Pₑ/P_{w}≦0.4, and

0.4≦τ_{w}/(τ_{w}+τ_{b})≦0.8,

where τ_{w} denotes the sum of the length of the heating pulses, and τ_{b} is the sum of the length of the cooling pulses.

In the second aspect, the space is formed at least by an erase pulse of power Pₑ,

the mark is formed by a heating pulse irradiating a power of P_{w} while P_{w}>Pₑ, and the Pₑ and the P_{w} satisfy the following equations: 0.15≦Pₑ/P_{w}≦0.5.

The detail of the optical recording medium of the present invention is revealed hereinafter through the illustration of the optical recording method of the present invention.

First of all, in order to form an optical recording medium with which a high-speed re-writing is possible, a phase-change material with fast crystallization speed is generally used for a recording layer, or the crystallization speed is accelerated by combining with a protective layer. When the crystallization is fast, an amorphous mark may be erased at high speed, and a high-speed re-writing is possible. However, the crystallization speed cannot be largely increased since the increased crystallization speed in accordance with a high-speed recording causes problems as mentioned above. Also, when an optical recording medium has insufficient crystallization speed, a residual of an amorphous mark remains in high-speed recording, causing a reproducing error.

Materials which are practically used as a recording layer of a phase-change optical recording medium are largely categorized in ones with Te as a main component and others with Sb as a main component, and optical disc systems including DVD+RW and DVD-RW in which a recording is performed only in a groove use a recording layer having Sb as a main component. A recording layer having Sb as a main component can provide favorable re-writing performance with relatively simple layer composition and high compatibility with a read-only optical apparatus. Regarding the crystallization process from an amorphous state, nucleation is dominant in a material having Te as a main component while crystal growth from an amorphous region or the boundary of melting region and crystaine region in a material having Sb as a main component. Therefore, with a recording layer having Sb as a main component, the time required for complete crystallization is long with a large amorphous mark, and the time is short with a small mark. Therefore, without the necessity of accelerating the crystallization up to a speed to cause various problems, speed and favorable re-writing performance may be achieved by employing a specific optical recording method and by recording a narrow amorphous mark.

Here, in DVD, a groove means a salient portion of a guide groove in the direction of an incoming light while a land is a depressed portion. In addition, in an optical disc system with a blue LD, there are cases where a groove is the depressed portion while a land is the salient portion. In either case, the recording in a groove in the present invention means a recording in a recording layer corresponding to any one of the salient portion and the depressed portion of the guide groove.

### —Relation Between Crystallization Speed and Recording Speed—

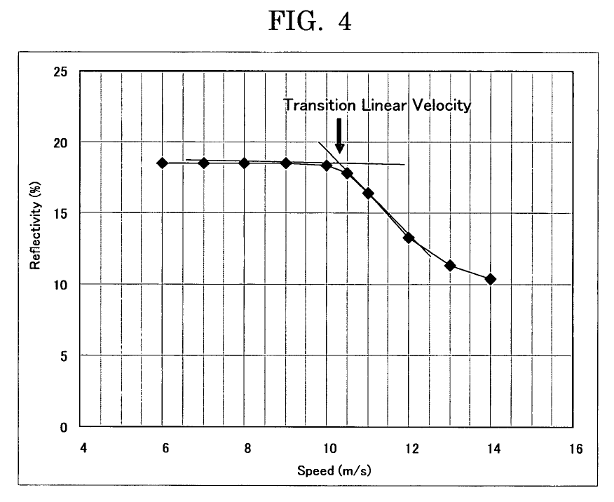

As an alternative property to the crystallization speed, a value of transition linear velocity may be employed. The transition linear velocity may be measured with an apparatus generally used for evaluating recording and reproducing performances, DDU-1000 and ODU-1000 manufactured by Pulstec Industrial Co., Ltd. The transition linear velocity may be obtained by measuring the reflectivity after irradiating a laser beam in a circle with an intensity enough to melt the recording layer while the optical recording medium is rotated at a constant linear velocity. The same measurement is repeated with varied rotational linear velocities while the power of the continuously irradiated light is maintained constant, and the reflectivity starts to decrease at or above a certain linear velocity while the reflectivity remains high at a low linear velocity. This linear velocity at which the reflectivity starts to decrease is called the transition linear velocity. This is illustrated in FIG. 4. In this diagram, straight lines are drawn at the portion with almost constant reflectivity with respect to linear velocity and the portion with decreasing reflectivity, and the point of intersection is determined as the transition linear velocity. The recording layer is at a state where it is completely re-crystallized after melting at a linear velocity below the transition linear velocity. At a linear velocity above the transition linear velocity, the recording layer cannot be completely re-crystallized after melting, and the recording layer partially remains as an amorphous phase. The transition linear velocity is determined by not only the crystallization speed of the recording layer but also the power of continuously irradiated light and the thickness of the layers comprised in the optical recording medium, i.e. optical conditions and thermal conditions.

When a continuous light having a surface power of 15±1 mW is irradiated with a pick-up head having a wavelength of 650±10 nm and a numerical aperture of 0.65±0.01, a favorable recording at 8×-speed (about 28 m/s) of DVD may be obtained with the configuration of the recording layer composition and the layer composition of the optical recording medium such that the transition linear velocity is 21 m/s to 30 m/s.

However, when a recording at a higher linear velocity such as 10×-speed (about 35 m/s) and 12×-speed (about 42 m/s) of DVD is performed on the same optical recording medium with the same optical recording method as the one used for recording at 8×-speed, a residual of the amorphous mark remains, and favorable re-writing performance cannot be achieved because of the low crystallization speed with respect to the recording speed. Therefore, it was considered that an optical recording medium having a transition linear velocity exceeding 30 m/s is necessary for re-writing at 10×-speed or higher. However, as stated above, the defects such as occurrence of abnormal re-crystalline particles and cross light became apparent, and favorable rewriting performance could not be achieved simply by employing an optical recording medium having a high transition linear velocity. Given this factor, a recording was performed with a specific recording method on an optical recording medium having a transition linear velocity of 21 m/s to 30 m/s, which is equivalent to the one at 8×-speed such that a recorded amorphous mark is narrow, and favorable re-writing performance was achieved even at 10×-speed or greater. Moreover, the optical recording medium has the same linear velocity as that for an 8×-speed recording, and a backward compatibility was maintained at up to 8×-speed that a recording was possible with a conventional recording drive. It requires caution that a narrow mark is recorded even at a low speed or that a recording is performed only in a linear velocity region limited by the radial location since favorable characteristics cannot be achieved when a narrow mark is overwritten on a portion with a wide mark recorded in a conventional manner.

In the optical recording method of the present invention, when a recording and reproducing is performed with a laser beam having a wavelength of 640 nm to 660 nm, a recording is performed preferably at 10×-speed or greater, and more preferably at 10×-speed to 16×-speed. Here, the reference speed, i.e. 1×-speed, is about 3.5 m/s.

In addition, an optical disc system which enables a higher-density recording by means of a laser diode having a wavelength of 405±5 nm such as Blu-ray Disc and HD DVD RW also employs a method of recording only at a groove. The reference speed (1×-speed) is 4.92 m/s for Blu-ray Disc and 6.61 m/s for HD DVD RW, and each has been in practical use or developed up to 1×-speed to 2×-speed. A similar optical recording method may also be effectively applied to these optical systems in high-speed recording. When the transition linear velocity was measured with a surface power of 5 mW to 6 mW, favorable rewriting performance was obtained by applying an optical recording method with a mark width narrowed at 4×-speed for an optical recording medium in the range of 15 m/s to 19 m/s.

In the optical recording method of the present invention, when a recording and reproducing is performed with a laser beam having a wavelength of 400 nm to 410 nm, a recording is performed preferably at 4×-speed or greater, and more preferably 4×-speed to 8×-speed.

### —Mark Width and Modulation—

The width of an amorphous mark may be judged by examining the modulation M of the longest mark. When the signal recording method is EFM+modulation, the modulation M is expressed as (I14H-I14L)/I14H where I14H is the reflectivity of a 14T space as the longest signal, and I14L is the reflectivity of a 14T mark. A mark is wide when the modulation M is large. A mark is narrow when the modulation M is small.

The modulation M is large in view of the reproducing compatibility with a ROM. For DVD+RW, it is preferably 0.60 for an optical recording which can record at up to 4×-speed and 0.55 or greater for an optical recording medium which can record at 8×-speed.

In the present invention, the modulation M is preferably 0.35 to 0.60. When the modulation M is less than 0.35, the jitter and error may increase since a favorable recording and reproducing cannot be performed even from the initial recording. When the modulation M exceeds 0.60, the jitter and error may increase in re-writings even though the first recording is favorable because of a mark remained as a residual.

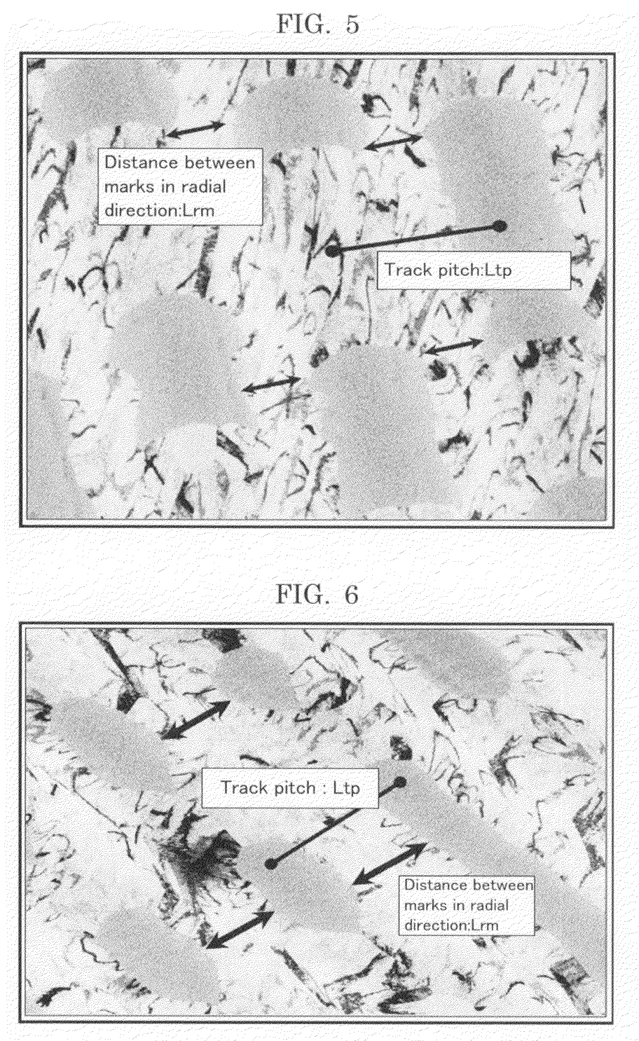

On an optical recording medium in which a recording at 8×-speed is possible, a recording is performed such that the modulation M is 0.63, and the optical recording medium is observed under a transmission electron microscope (TEM). The observation reveals that an amorphous mark on an optical recording medium for recording only in the groove portion such as DVD+RW and DVD-RW has a width wider than the groove width as shown in FIG. 5. In general, the ratio of the land width and the groove width is 1 to 1, so the track pitch, Lₜₚ, the distance between marks in two tracks adjacent in the radial direction, Lᵣₘ, and the average of Lᵣₘ, A(Lᵣₘ), have a relation of A(Lᵣₘ)<1/2·Lₜₚ. When a high-speed rewriting is performed on this medium at 10×-speed or greater of DVD, a wide mark cannot be completely crystallized. Therefore, the mark remains as a residual, causing the increase in the jitter and error. However, as shown in FIG. 6, by recording such that a relation of A(Lᵣₘ)≧1/2·Lₜₚ, complete crystallization is possible even in a high-speed rewriting at a speed of 10×-speed (about 35 m/s) to 12×-speed (about 42 m/s) of DVD, and a favorable re-writing may be performed. However, the modulation of the example in FIG. 6 was small at about 0.50. Although the mark width is not checked under TEM, it was found other than the example in FIG. 6 that favorable re-writing performance at a high speed may be obtained when a recording was performed such that the modulation M of the longest mark was 0.35 to 0.60.

The error rate might increase as described above with a small modulation of a recording mark, but the electrically dynamic range of the modulation is important since a reproducing apparatus electrically converts and reads the optical modulation of the mark by means of a detector such as photo diode. When the reflectivity is small, there is a potential increase in the error rate caused by the difficulty in allocating a dynamic range due to the small absolute value of an electric signal even though the modulation is large. On the other hand, when the reflectivity of the optical recording medium as a whole is large despite the small modulation, the dynamic range of an electric signal corresponding to the modulation may be widened because of the absolute value of the signal. In a DVD system, the minimum reflectivity is 18% according to a two-layer ROM, DVD+RW and DVD-RW standards, and the same width of the dynamic range is ensured after the transformation to an electric signal when the product of the modulation and the reflectivity is configured constant.

Therefore, in a DVD system, the same dynamic range can be obtained, and the increase in the error rate can be suppressed when the product of the modulation and the reflectivity is 0.18×0.60=0.108 or greater.

In the present invention, the reflectivity of 27% or greater will suffice when the modulation is 0.40 to 0.55 for sufficient performance within the range of 10×-speed to 16×-speed with a mark narrower than the groove width. Also, an optical recording medium with low reflectivity does not necessarily have to satisfy this relation when it has no problem in reproducing. In this regard, however, the maximum reflectivity for a re-writable DVD medium is 30% or less since an optical reproducing apparatus has difficulty in determining whether an optical recording medium with high reflectivity is re-writable or read-only due to the nature of the DVD system. Also, an optical disc system which employs a blue LD can handle an optical recording medium with lower reflectivity, and the minimum reflectivity of 0.05 for a single layer and 0.016 for a double layer should be satisfied.

Next, an optical recording method for recording a mark such that the mark width is maintained narrow is described.

A recording is performed on an optical disc having a phase-change medium as its recording layer by putting the recording layer material in a quenched condition and an annealed condition. After being melted, a recording layer material becomes amorphous when quenched, and it crystallizes when annealed. Optical properties of an amorphous phase and a crystal phase are different; therefore, information may be recorded and reproduced. That is, a phase-change optical recording medium repeatedly records information by irradiating a laser beam on a thin-film recording layer on a substrate to heat the recording layer and induce a phase change between crystal and amorphous phases in the recording layer structure to modify the reflectivity of the disc. In general, a crystal phase with high reflectivity represents a non-recorded state, and information is recorded by forming an amorphous mark with low reflectivity and a crystal space with high reflectivity.

Information is usually performed by irradiating a recording light which has been under intensity modulation where the pulse is divided into three or more values.

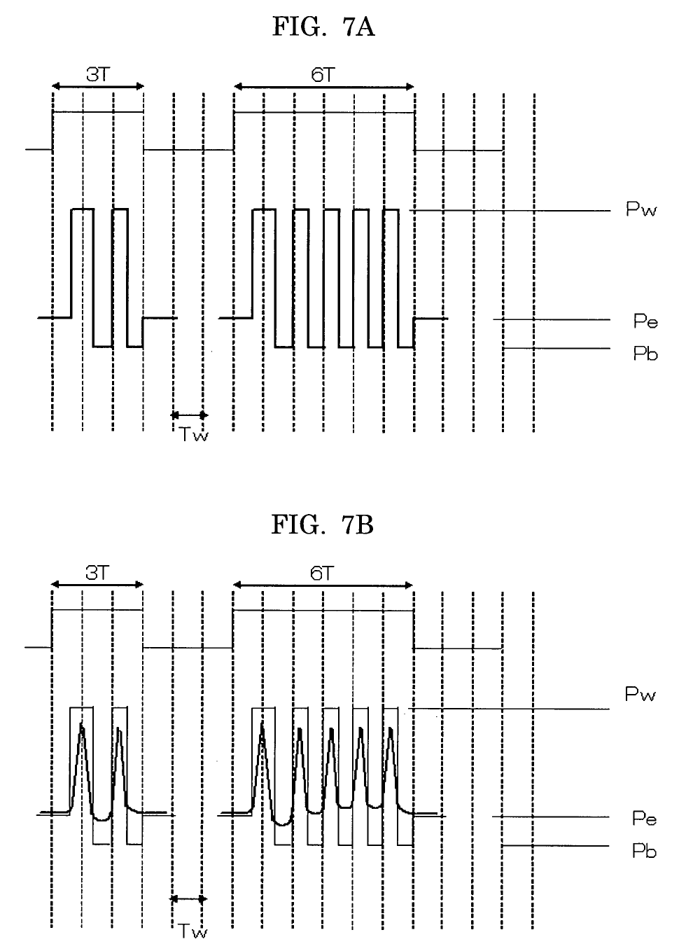

FIG. 7A shows an example of a recording signal pattern, i.e. write strategy, for re-writing data consisting of marks and spaces. A mark of an amorphous phase is formed by a multi pulse which alternatively irradiates a heating pulse of power P_{w} and a cooling pulse of power P_{b}, where P_{w}>P_{b}. A space of a crystal phase is formed by irradiating an erase pulse of power Pₑ of the medium intensity. When a heating pulse and a cooling pulse are alternatively irradiated, a recording layer alternates between melting and quenching to form an amorphous mark. When an erasing pulse is irradiated, the recording layer is melted and then annealed or annealed while it is in a solid state for crystallization, and a space is formed. FIG. 7A is an example of a 1T write strategy in which the period of the pulse which forms an amorphous mark is 1T, where T denotes a reference clock period. The 2T write strategy is used for a high-speed recording or a low-speed recording on a medium having high crystallization speed, where the pulse period is 2T.

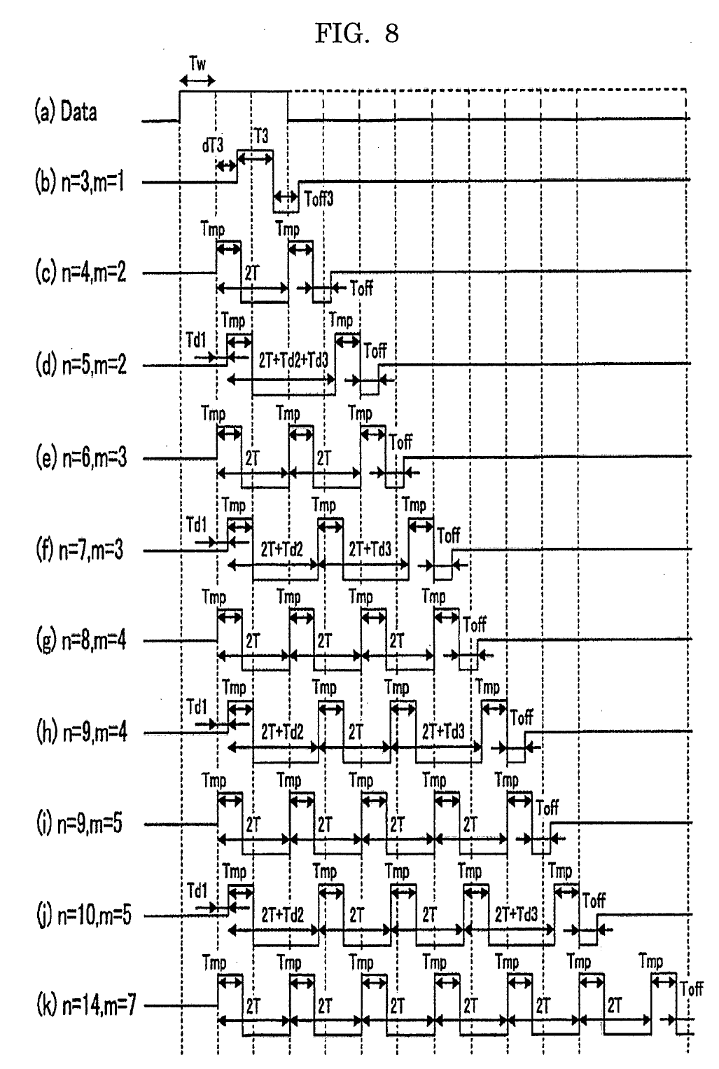

FIG. 8 shows an example of a 2T write strategy. This is an example of an optical recording method disclosed in JP-B No. 3572068, where the intensity modulation of a writing light is performed by irradiating alternatively by m times a heating pulse of power P_{w} and a cooling pulse of power P_{b}, where P_{w}>P_{b}, n=2m for an even n, and n=2m+1 for an odd n. It is disclosed that such write strategy allows a wide range of modulation for a recording speed of up to 10×-speed compared to 1T write strategy used for, for example, 4×-speed DVD+RW.

A conventional phase-change disc for recording in a groove uses an optical recording medium having a high crystallization speed; therefore, it has been considered advantageous to employ the 2T write strategy for ensuring a sufficient cooling time with increased power of the heating pulse and shortened irradiation time for the purpose of preventing re-crystallization during recording and for forming an amorphous mark having a certain size. However, it is now clear that the use of a strategy which does not allocate a long period of time for cooling and furthermore a block write strategy which does not allocate a cooling pulse are effective for a high-speed recording at 10×-speed or greater of DVD even for the cases where the 1T write strategy for recording at 4×-speed of DVD+RW or the 2T write strategy are used. This is because these strategies enable a recording without enhancing the mark width.

### —1T Write Strategy—

The 1T write strategy is explained with an example of a 1T write strategy shown in FIG. 7A. A write strategy as such is used for a relatively slow phase-change optical recording medium of up to 4×-speed such as DVD+RW, and it employs a pulse modulation method. In a 4×-speed recording, the reference period T_{w} is about 9.5 ns. When the duty ratio is about 0.5 as a normal pulse duty, the time constants of the heating pulse for melting the recording layer material (P_{w}) and the cooling pulse for cooling this and forming an amorphous layer as a recording mark (P_{b}) are 4.25 ns, respectively. In this case, a sufficient cooling period is ensured, given that the laser beam actually has leading and falling edges of 1.5 ns to 2 ns.

However, when the 1T write strategy is used for a 12×-speed DVD+RW, for example, the time constants for heating pulse and cooling pulse are about 1.6 given the duty ratio of 0.5. Therefore, the heating pulse and the cooling pulse do not reach their set values. This is observed from the waveform of the pulses emission in FIG. 7B. When the 1T write strategy is applied for a recording at 10×-speed or greater, a sufficient area cannot be melted because of the insufficient rise time of P_{w} compared to a low-speed recording, and re-crystallization proceeds faster because of the insufficient fall time of Pb. Compared to the case where the melted area has a low crystal growth speed and the case where the 2T write strategy is applied, re-crystallization can proceed more rapidly, and as a result, the amorphous area can be reduced. Therefore, an optical recording method with reduced recording mark width and modulation for a favorable erase ratio, i.e. for enabling rewriting, can be obtained in a high-speed recording, which is the primary purpose of the present invention.

Here, for each mark length having a length of 4T or greater, τ_{w} denotes the sum of the irradiation period of the heating pulse P_{w}, τ_{b} denotes the sum of the irradiation period of the cooling pulse Pb, and the value of τ_{w}/(τ_{w}+τ_{b}) is preferably 0.4 or greater. When the value of τ_{w}/(τ_{w}+τ_{b}) is less than 0.4, it is evident that the rise time is not enough for the heating pulse P_{w}, and sufficient melted area cannot be allocated even though the value of P_{w} is set high. Also, there is a tendency that the favorable jitter cannot be obtained with too large value of τ_{w}/(τ_{w}+τ_{b}). The value should be 0.8 or less, and preferably 0.7 or less. It is more advantageous to perform a recording by means of a block write strategy which only involves a long pulse of P_{w} instead of multi pulse, rather than to set the value of τ_{w}/(τ_{w}+τ_{b}) to greater than 0.8. This is solely based on experimental results, and the reason is unclear.

Regarding a mark shorter than 4T, i.e. 3T for DVD and 2T and 3T for Blu-ray Disc and HD DVD, the value of τ_{w}/(τ_{w}+τ_{b}) is not necessarily maintained within the range of 0.4 to 0.8.

In addition, a space is formed by irradiating Pₑ, and the value of Pₑ/P_{w} is 0.15 to 0.4. When the value of Pₑ/P_{w} is less than 0.15, the power to erase a recorded amorphous mark may be insufficient. When the value of Pₑ/P_{w} exceeds 0.4, the jitter degrades even from the initial recording for unknown reasons.

### —2T Write Strategy—

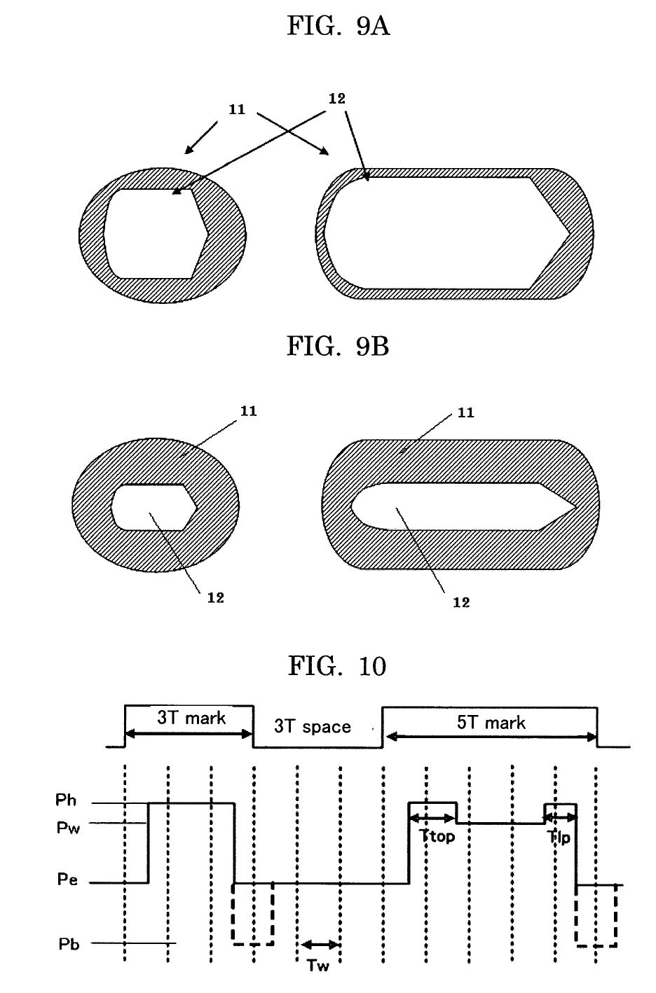

FIGS. 9A and 9B show examples of a write strategy with the value of τ_{w}/(τ_{w}+τ_{b}) varied and the relation of the relation of a re-crystallization area 11 and an amorphous mark 12, where for each mark length having a length of 4T or greater, τ_{w} denotes the sum of the irradiation period of the heating pulse P_{w}, τ_{b} denotes the sum of the irradiation period of the heating pulse P_{w}. FIG. 9A is an example with a small value of τ_{w}/(τ_{w}+τ_{b}), and FIG. 9B is an example with a large value of τ_{w}/(τ_{w}+τ_{b}). When the peak power is adjusted so that the area of a melted region is maintained almost constant, the mark is narrower with a larger fraction of P_{w}, i.e. a larger value of τ_{w}/(τ_{w}+τ_{b}), since more area is re-crystallized. Therefore, a shorter cooling pulse is preferable to record a mark with small width at a high speed. The value of τ_{w}/(τ_{w}+τ_{b}) is preferably 0.4 or greater. When the linear velocities are equivalent for the 1T write strategy and 2T write strategy, the value may be less than 0.4 in terms of the sufficient rise time for P_{w} and melted area since the τ_{w} for the 2T write strategy is twice as long. This in turn increases the time for the cooling pulse. As a result, re-crystallization does not proceed, and the mark width cannot be reduced. Also, there is a tendency that the favorable jitter cannot be obtained with too large value of τ_{w}/(τ_{w}+τ_{b}. The value should be 0.8 or less. It is more advantageous to perform a recording by means of a block write strategy which only involves a long pulse of P_{w} instead of multi pulse rather than to set the value of τ_{w}/(τ_{w}+τ_{b}) to greater than 0.8. This is solely based on experimental results, and the reason is unclear.

Regarding a mark shorter than 4T, i.e. 3T for DVD and 2T and 3T for Blu-ray Disc and HD DVD, the value of τ_{w}/(τ_{w}+τ_{b}) is not necessarily maintained within the range of 0.4 to 0.8.

In addition, a space is formed by irradiating Pₑ, and the value of Pₑ/P_{w} is 0.15 to 0.4. When the value of Pₑ/P_{w} is less than 0.15, the power to erase a recorded amorphous mark may be insufficient. When the value of Pₑ/P_{w} exceeds 0.4, the jitter degrades even from the initial recording for unknown reasons.

### —Block Write Strategy—

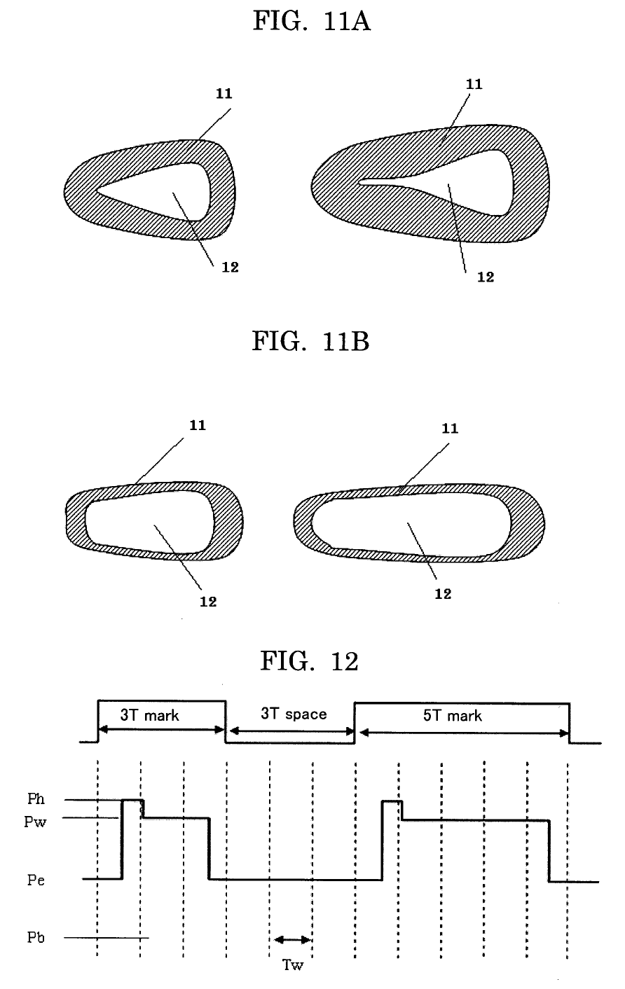

As shown in FIG. 10, a long pulse of only P_{w} may be irradiated instead of a multi pulse. Such continuous light has been considered unfavorable since it forms a mark in the shape of a teardrop as shown in FIG. 11A. Such teardrop mark causes a reproducing error and leaves residual at the back-end wide portion in rewriting. One of the reasons for the formation of a teardrop mark is that the heat accumulation effect increases the temperature near the back end of the mark. Another reason is that the continuous heating promotes the re-crystallization.

The heat accumulation effect is eased at a speed of 8×-speed or higher of DVD, and it is further eased when the optical recording medium has a quench configuration. As a result, the melted region does not easily spread in the form of a teardrop. An optical recording medium which was once considered as too slow for its low crystallization speed can produce a mark which is long but has a favorable shape as shown in FIG. 11B since the medium also has a low re-crystallization speed.

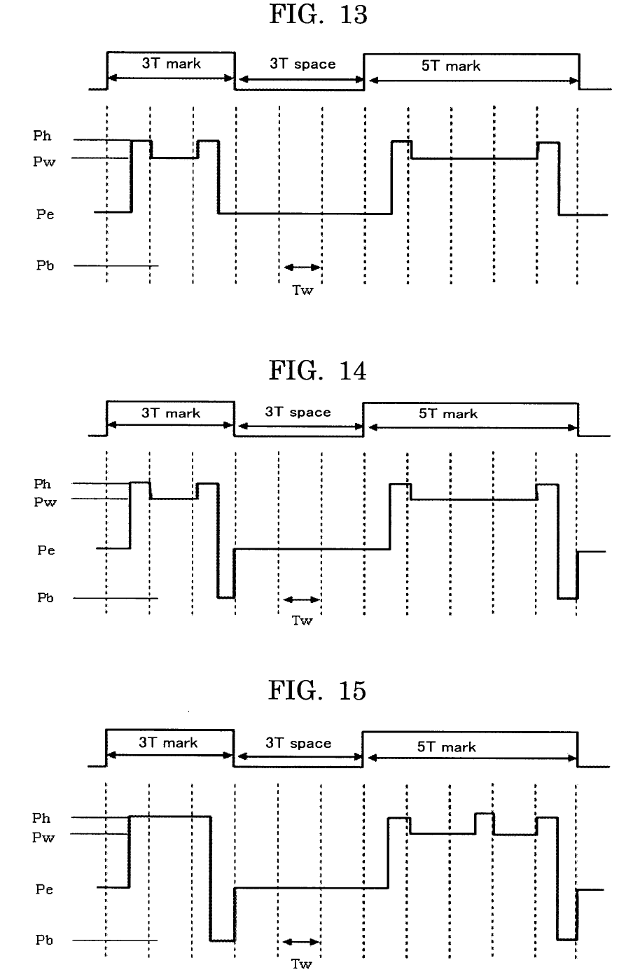

Furthermore, as shown in FIGS. 12 to 15, the properties may be improved by briefly applying a power Pₕ which is stronger than P_{w} to the front, rear or middle of a block of P_{w} pulses or by applying a cooling pulse Pb at the transition from a block of P_{w} pulses to an erasing pulse of Pₑ. In FIGS. 12 to 14, the Pₕ is briefly applied to a 3T pulse; the whole pulse may have an intensity of P_{w} since a 3T period is short.

In addition, a space is formed by irradiating Pₑ, and the value of Pₑ/P_{w} is 0.15 to 0.5. When the value of Pₑ/P_{w} is less than 0.15, the power to erase a recorded amorphous mark may be insufficient. When the value of Pₑ/P_{w} exceeds 0.5, the jitter degrades even from the initial recording for unknown reasons.

### <Pre-Formatting Optical Recording Medium>

The optical recording medium used for the optical recording method of the present invention has information related to the optical recording method of the present invention recorded beforehand on its substrate.

It is preferable to pre-format on an optical recording medium parameters related to the write strategy such as T_{d1}/T, T_{off}, T_{d2}, T_{d3}, dT₃, Tₘₚ, T₃ and T_{off3}, which are examples of the 2T write strategy in FIG. 8, since these parameters are specific to the optical recording medium. It is also preferable to pre-format parameters for the cases with the 1T write strategy and the block write strategy and for the case with the 2T write strategy where the parameters are differently defined from those in FIG. 8. An optical recording apparatus can configure optimum recording parameters, i.e. write strategy, for a given scanning velocity, v, by reading these parameters pre-formatted on a subject optical recording medium prior to operation. Also, pre-formatted write power information simplifies the configuration for more optimum recording conditions.

Any pre-formatting method may be employed, and examples thereof include a pre-pit method, a wobble encoding method and a formatting method.

The pre-pit method is a method of pre-formatting information concerning the recording conditions using a ROM pit in any given area of the optical recording medium. This method is advantageous in regard to high productivity for the formation of the ROM pit in the substrate formation as well as high reproducing reliability and information volume for the use of the ROM pit. However, there are still many problems that need to be solved concerning the technology for forming a ROM pit, i.e. hybrid technology, and the pre-formatting technology using a RW pre-pit is still considered to be quite difficult.

The formatting method is a method for recording information in the same manner as an ordinary recording in an optical recording apparatus. However, it is required for this method that an optical recording medium should be formatted after its production, which is difficult in terms of mass production. Furthermore, it is not appropriate as a method for recording information specific to an optical recording medium since the pre-formatted information is re-writable.

The wobble encoding method is a method adopted in practice for pre-formatting a CD-RW and a DVD+RW. This method employs a technology of encoding address information of an optical recording medium in the wobble of a grove, i.e. the guide groove of the recording medium. The encoding method may be a frequency modulation used for the ATIP (Absolute Time in Pre-groove) for a CD-RW or a phase modulation used for a DVD+RW. The wobble encoding method is advantageous in terms of productivity since the groove wobble is formed on the substrate of an optical recording medium together with the address information during the formation of the substrate. At the same time, unlike the pre-pit method where a special ROM pit should be formed, the wobble encoding method does not require such special measure, thereby facilitating the formation of the substrate.

The optical recording medium used for the optical recording method of the present invention is not particularly restricted and can be appropriately selected according to applications. The optical recording medium includes a substrate having a guide groove and at least a phase-change recording layer on the substrate; it further includes other layers according to requirements.

### —Phase-Change Recording Layer—

The recording layer employs as its mother phase a material which includes Sb as the main component with additional elements for promoting the transformation to the amorphous phase. Examples thereof include Sb—In system, Sb—Ga system, Sb—Tb system and Sb—Sn—Ge system. Here, the main component is defined as a component having a composition of 50% by atom or greater. Also, other elements are added to these mother phases for the purpose of improving various characteristics.

The Sb—In system preferably has the following composition range:

(Sb₁₋ₓInₓ)_{1-y}M_{y}

where 0.15≦x≦0.27, 0.0≦y≦0.2, and M represents one or more type of element other than Sb and In.

Favorable re-writing performance can be obtained with a two-component system of Sb and In with high crystallization temperature of around 170° C. and superior preservation stability of the amorphous phase. The element M is favorably added for the purpose of further improving the preservation stability, improving the rewriting durability and the ease of formatting. Any one element selected from Al, Si, Ti, V, Cr, Mn, Cu, Zn, Ge, Ga, Se, Te, Zr, Mo, Ag and a rare-earth element may be added as the element M. The addition of these elements is prone to decreasing the crystallization speed; therefore, Sn or Bi may be further added to improve the crystallization speed. The total content of the element M is preferably 20% by atom or less so that the rewriting performance is not sacrificed.

The Sb—Ga system is preferably used in the following composition range:

(Sb₁₋ₓGaₓ)_{1-y}M_{y}

where 0.05≦x≦0.2, 0.0≦y≦0.3, and M represents one or more type of element other than Ga and Sb.

Favorable rewriting performance can be obtained with a two-component system of Sb and In with high crystallization temperature of around 180° C. and superior preservation stability of the amorphous phase. The increase in the ratio of Sb for higher crystallization speed, however, causes problems such as non-uniform reflectivity after formatting; therefore, the element M is favorably added to improve the non-uniformity of the reflectivity for high-speed recording. Examples of the element M include Al, Si, Ti, V, Cr. Mn, Cu, Zn, Se, Zr, Mo, Ag, In, Sn, Bi and a rare-earth element. The addition of these elements reduces the crystallization stability and the reflectivity after storage at a room temperature or a high temperature, causing a problem that a recording cannot be performed under the conditions equivalent to those prior to storage. Therefore, Ge or Te may be further added. The total content of the element M is preferably 30% by atom or less so that the rewriting performance is not sacrificed.

The Sb—Te system is preferably used in the following composition range:

(Sb₁₋ₓTeₓ)_{1-y}M_{y}

where 0.2≦x≦0.4, 0.03≦y≦0.2, and M represents one or more type of element other than Sb and Te.

Favorable re-writing performance can be obtained with a two-component system of Sb and Te, but there is a problem that a recording mark crystallizes in high-temperature storage since the two-component system has a low crystallization temperature of around 120° C. Therefore, the addition of the element M is necessary for increasing the crystallization temperature and improving the stability of the amorphous phase. Examples of the element M which improves the stability of the amorphous phase include Al, Si, Ti, V, Cr, Mn, Cu, Zn, Ga, Ge, Se, Zr, Mo, Ag, In and a rare-earth element. The addition of these elements is prone to decreasing the crystallization speed, so Sn or Bi may be further added to improve the crystallization speed. The addition is not effective unless the total content of the element M is 3% by atom or greater, and it is preferably 20% by atom or less so that the re-writing performance is not sacrificed.

The Sb—Sn—Ge system is preferably used in the following composition range:

(Sb_{1-x-y}SnₓGe_{y})_{1-z}M_{z}

where 0.1≦x≦0.25, 0.03≦y≦0.30, 0.00≦z≦0.15, and M represents one or more type of element other than Sb, Sn and Ge.

Favorable re-writing performance can be obtained with a three-component system of Sb, Sn and Ge, yet the addition of one or more elements reduces the jitter. Examples of the effective element include Al, Si, Ti, V, Cr, Mn, Cu, Zn, Ga, Ge, Se, Tb, Zr, Mo, Ag, In and a rare-earth element. Since an excessive addition in turn degrades the jitter, the total content of the element M is preferably at most 15% by atom or less.

The recording layer preferably has a thickness of 6 nm or greater. When the thickness is less than 6 nm, the crystallization and the modulation are extremely decreased, and a favorable recording is difficult. The maximum thickness is preferably 30 nm or less and more preferably 22 nm or less for a single-layer structure and the back layer in a double-layer structure. It is preferably 10 nm or less and more preferably 8 nm or less for the front layer in a double-layer structure. The recording layer with a thickness exceeding the above range has a decreased recording sensitivity and degraded re-writing durability. For the case of the front layer in a double-layer structure, the intensity of the transmitted light cannot be secured, and hence the recording and reproducing in the back layer becomes difficult.

The layer composition other than the phase-change recording layer is equivalent to that of the optical recording medium below.

### (Optical Recording Medium)

The optical recording medium of the present invention includes a substrate having a guide groove and at least a phase-change recording layer on the substrate. It further includes a first protective layer, a second protective layer, a reflective layer and other layers according to requirements.

The rotational linear velocity of the optical recording medium is a variable, and the transition linear velocity corresponding to the point at which the reflectivity measured by the irradiation of a continuous light with a pick-up head on the optical recording medium starts to decrease is 5 m/s to 35 m/s.

### —Transition Linear Velocity—

The transition linear velocity is used as an indication for designing an optical recording medium which exhibits appropriate re-writing performance with respect to varied recording linear velocities. The transition linear velocity may be measured with an apparatus generally used for evaluating recording and reproducing performances, DDU-1000 and ODU-1000 manufactured by Pulstec Industrial Co., Ltd. The transition linear velocity may be obtained by measuring the reflectivity after irradiating a laser beam in a circle with an intensity enough to melt the recording layer while the optical recording medium is rotated at a constant linear velocity. More specifically, the same measurement is repeated with varied rotational linear velocities while the power of the continuously irradiated light is maintained constant, and the reflectivity starts to decrease at or above a certain linear velocity while the reflectivity remains high at a low linear velocity. This linear velocity at which the reflectivity starts to decrease is called the transition linear velocity. This is illustrated in FIG. 4. In this diagram, straight lines are drawn at the portion with almost constant reflectivity with respect to linear velocity and the portion with decreasing reflectivity, and the point of intersection is determined as the transition linear velocity. The recording layer is at a state where it is completely re-crystallized after melting at a linear velocity below the transition linear velocity. At a linear velocity above the transition linear velocity, the recording layer cannot be completely re-crystallized after melting, and the recording layer partially remains as an amorphous phase. The transition linear velocity is determined by not only the crystallization speed of the recording layer but also the power of continuously irradiated light and the thickness of the layers comprised in the optical recording medium, i.e. optical conditions and thermal conditions.

The power of the continuous light for measuring the transition linear velocity should be sufficient for melting the phase-change optical recording layer when the continuous light is irradiated to the optical recording medium rotated at a rotating velocity near the targeted transition linear velocity. Whether the recording layer has melted may be determined based on the change in the reflectivity of the optical recording medium when the continuous light is irradiated at the linear velocity. When there is no change in the reflectivity, it can be safely said that the power is insufficient to melt the recording layer. Therefore, the light with increased power may be irradiated. A rough indication is that the power is about one-half to two-thirds of the recording power. The required power increases as the transition linear velocity increases.

When the transition linear velocity measured with the above method is 5 m/s or greater, a re-writing is possible at a speed of at least a reference speed of major optical disc systems such as DVD having a reference speed of 3.5 m/s, Blu-ray Disc having a reference speed of 4.92 m/s and HD DVD having a reference speed of 6.61 m/s. When the transition linear velocity is smaller, the re-writing at a reference speed is not possible because of a residual amorphous mark in overwriting. To increase the recording speed to, for example, 2×-speed and 3×-speed, it is more preferable to configure the recording layer composition and the layer composition of the optical recording medium for a higher transition linear velocity. When the upper limit of the rotational speed of the motor in the drive is assumed to be 10,000 rpm, the maximum speed at the outermost periphery is about 60 m/s since an optical recording medium for the major optical disc systems has a diameter of 12 cm. Therefore, it can be inferred that the maximum speed is 16×-speed for DVD, 12×-speed for Blu-ray Disc and 9×-speed for HD DVD despite the effort of speeding up for the systems. Even though a recording at a speed of 60 m/s is assumed, the appropriate upper limit of the transition linear velocity is around 35 m/s. This is because the medium is prone to re-crystallization in recording with increasing transition linear velocity, and the formation of an amorphous mark with a sufficient size becomes difficult. Therefore, an appropriate selection of the recording layer composition and the layer composition provides an optical recording medium which enables a recording at a recording speed in the range of the reference speed of the respective optical disc systems to 60 m/s.

There are cases such as CAV recording where the recording speed is different at the innermost periphery and the outermost periphery of the disc. For example, the rotational speed is constant, and the recording speed is 5×-speed of DVD at the innermost periphery and 12×-speed at the outermost periphery, and the velocity sequentially increases in between. In this case, one optical recording medium having a recording layer of a uniform composition and having a uniform layer composition is formed, and a recording may be performed at 5×-speed to 12×-speed by optimizing the write strategy and the write power. However, this is difficult because of the restrictions in the configurations of the strategy and the write power. In that regard, the disc may have different transition linear velocities at the inner and outer portions of the disc, and the recording may be more easily performed with a more appropriate linear velocity according to the radial location.

The optical recording medium should be configured such that the transition linear velocity is low for the inner portion for low-speed recording and high for the outer portion for high-speed recording. For an optical recording medium with a recording speed varying from 5×-speed to 12×-speed of DVD, the transition linear velocities are preferably 12 m/s to 26 m/s at the inner part and 20 m/s to 35 m/s at the outer part.

The transition linear velocity may be varied by changing the composition of the recording layer or changing the layer composition. Regarding the composition of the recording layer, the increased composition of Zn decreases the crystallization speed and accordingly the transition linear velocity; the composition of Zn is high for the inner portion and low for the outer portion. A material having an increased composition of Sn by partially substituting Sb with Sn increases the crystallization speed and accordingly the transition linear velocity; the composition of Sn is low for the inner portion and high for the outer portion. A film having different composition at the inner and outer portions may be formed by changing the target of a sputter for the inner and outer portions.

The transition linear velocity may also be varied with the layer composition, and it may be adjusted with the layer composition. Various methods may be applied, and an adjustment by means of the thickness of the recording layer is relatively simple. Compositions being equal, the recording layer having a small thickness tends to have smaller transition linear velocity. Therefore, the thickness is smaller at the inner portion of the disc and thicker at the outer portion of the disc. The thin recording layer for the inner portion may be formed by installing a mask or a shutter at the inner portion in sputtering.

### <Phase-Change Recording Layer>

The In—Sb system exhibits the superior amorphous stability, low melting point and high crystallization speed, and it is appropriate as a material for high-speed recording. However, it has a problem of low crystalline stability, showing a large decrease in reflectivity in a high-temperature preservation test. The crystal is stabilized, and the decrease in the reflectivity may be reduced with increased In, i.e. decreased Sb, as indicated in the graph showing the relation between Sb/(In +Sb) and the decrease in the reflectivity (Δ%) in FIG. 23. The crystallization speed is increased similarly to the Sb—Teδ system when the fraction of Sb is increased for the crystalline stability in the In—Sb system. However, the important point is to obtain favorable re-writing performance not simply by increasing the crystallization speed but also by configuring the recording layer having appropriate crystallization speeds adjusted for the correlating recording linear velocities.

In this case, for example, the crystallization may be adjusted by varying the fractions of In and Sb, and the increased In will largely decrease the reflectivity as mentioned above. In this regard, a third element Zn is added to the In—Sb system having a higher fraction of Sb. Then, the crystallization speed may be adjusted by varying the added amount of Zn, and a re-writing with the low jitter may be performed.

It is also possible to adjust the crystallization speed by varying the amount of the third element when another element such as Ge and Te is added as the third element. Among these, Zn is superior, showing low jitter in high-speed re-writing and having re-writing durability. In addition, it is necessary in the present invention that the optical recording medium has not only a recording layer having a phase-change material with appropriately combined In, Sb and Zn but also a layer composition such that the value of the transition linear velocity lies within an appropriate range.

Therefore, the phase-change recording layer in the first aspect includes a phase-change material represented by Composition Formula (1) below:

(Sb₁₀₀₋ₓInₓ)_{100-y}Zn_{y} Composition Formula (1)

where, in Composition Formula (1), x and y denote the percentage of respective elements by atom, 10% by atom ≦x≦27% by atom, and 1% by atom ≦y≦10% by atom.

As mentioned above, the In—Sb system as a material for a phase-change recording layer with a large fraction of In is prone to large decrease in the reflectivity by 10% or greater after high-temperature storage. The fraction of In with respect to the total amount of Sb and In, i.e. x, is preferably 27% by atom or less, and more preferably 22% by atom or less.

FIG. 23 indicates that the reduction in the reflectivity of 7% or less, or 5% or less can be achieved with the fraction mentioned above.

The smaller reduction in the reflectivity due to high-temperature storage is favorable, and the inventors of the present invention have judged that a favorable recording is possible by readjusting the write strategy and the write power when the reduction in the reflectivity is 7% or less. The small fraction of In causes the non-uniformity in initialization, decrease the amorphous stability and reduces the modulation in recording; therefore, the fraction of In, i.e. x, is preferably 10% by atom or greater, and more preferably 15% by atom or greater.

The addition of Zn can promote the transition to amorphous phase, and the crystallization speed may be appropriately adjusted according to the recording speed by varying the amount of Zn. Also, the addition of Zn has an effect of decreasing the jitter in re-writing for unknown reasons. In general, re-writing gradually increases the jitter, but the increase may be suppressed by the addition of Zn compared to the cases where other elements are added. The addition of Zn also has an effect of improving the amorphous stability by increasing the crystallization temperature. The fraction of Zn, i.e. y in Composition Formula (1) above, is 1% by atom or greater, and preferably 2% by atom or greater.

However, too much addition of Zn decreases the crystallization speed, jeopardizing the high-speed recording. It also decreases the reflectivity in some portions in the initialization. Hence, the fraction of Zn, i.e. y in Composition Formula (1) above, is 10% by atom or less, and preferably 8% by atom or less.

A phase-change recording layer having superior re-writing performance, amorphous and crystalline stabilities and simple initialization may be designed by the appropriate combination of In, Sb and Zn within the range indicated in Composition Formula (1) above.

In addition, the phase-change recording layer in the second aspect includes a phase-change material represented by Composition Formula (2) below:

[(Sb_{100-z}Sn_{z})₁₀₀₋ₓInₓ]_{100-y}Zn_{y} Composition Formula (2)

where, in Composition Formula (2), x, y and z denote the percentage of each element by atom, 0% by atom ≦z≦25% by atom, 10% by atom ≦x≦27% by atom, and 1% by atom ≦y≦10% by atom.

The phase-change material represented by Composition Formula (2) above is equivalent to that represented by Composition Formula (1) with a partial substitution of Sb with Sn. In other words, it is a phase-change material having a composition in which a part of Sb (1% by atom to 25% by atom) is replaced by Sn as the main component of the phase-change recording layer. The partial substitution of Sb with Sn improves the crystallization speed and non-uniformity in initialization, and as a result favorable rewriting performance may be achieved. However, the fraction of Sn with respect to Sb, i.e. z, is 0% by atom to 25%, and preferably 2% by atom to 20% by atom. When the fraction of Sb exceeds 25% by atom, the modulation is reduced, and the jitter is not reduced.

By defining the recording layer and the transition linear velocity, the optical recording medium of the present invention has the high sensitivity, simple initialization, amorphous and crystal stabilities and can exhibit superior re-writing durability while maintaining the jitter low.

The x and y in Composition Formula (2) are equivalent to those in Composition Formula (1).

The phase-change recording layer has a thickness of preferably 6 nm to 22 nm, and more preferably 8 nm to 16 nm. Rewriting becomes difficult with the thickness of less than 6 nm because of various adverse effects such as reduced modulation, significant decrease in the crystallization speed and reduced stability of the reproducing light. When the thickness exceeds 22 nm, the increase in jitter after repeated re-writings becomes significant.

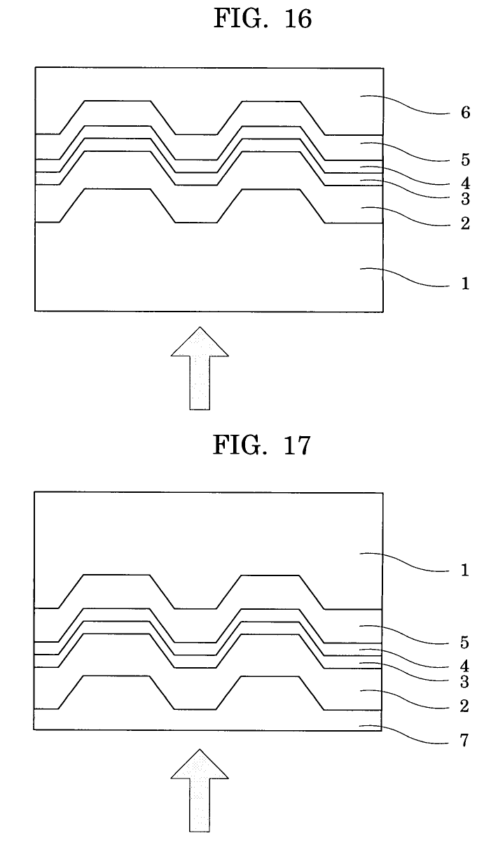

FIGS. 16 and 17 show configuration examples of optical recording media used for the optical recording method of the present invention. FIG. 16 is an example of a medium such as DVD+RW, DVD-RW and HD DVD RW. FIG. 17 is an example of a Blu-ray Disc.

In FIG. 16, on a transparent substrate 1 having a guide groove, at least a first protective layer 2, a recording layer 3, a second protective layer 4 and a reflective layer 5 are laminated in this order from the direction of the incoming light. For the cases of DVD and BD DVD, an organic protective layer is formed on the reflective layer 5 by the spin-coating method. A plate having the same size and usually the same material as the substrate is further bonded (not shown).

In FIG. 17, a transparent cover layer 7, a first protective layer 2, a recording layer 3, a second protective layer 4, a reflective layer 5 and a transparent substrate 1 having a guide groove are laminated in this order from the direction of the incoming light.

The optical recording media shown in FIGS. 16 and 17 are examples of an optical recording medium having a single-layer recording layer, and an optical recording medium having two recording layers with a transparent intermediate layer in between may also be used. In this case, the front layer with respect to the incoming light must be translucent since the recording and reproducing takes place in the back layer.

### —Substrate—

Examples of the substrate material include glass, ceramics and resins. Among these, resins are favorable in terms of formability and cost.

Examples of the resins include a polycarbonate resin, an acrylic resin, an epoxy resin, a polystyrene resin, an acrylonitrile styrene copolymer resin, a polyethylene resin, a polypropylene resin, a silicone resin, a fluorine resin, an ABS resin and a urethane resin. Among these, a polycarbonate resin and an acrylic resin are particularly preferable in terms of formability, optical properties and cost.

The substrate is formed such that the size, thickness and groove shape meet the standards.

A recording and reproducing is performed by controlling a laser beam to be irradiated at the center of the groove by means of the servo mechanism of a pick-up. For this control, the light diffracted by the guide groove in the vertical direction with respect to the scanning direction of the beam is monitored, and the laser beam is positioned at the center of the groove so that the lateral signal levels in the scanning direction are cancelled. The signal intensity of the diffracted light used for this control is determined by the relation between beam diameter, groove width and groove depth, and it is generally transformed into a signal intensity called as a push-pull signal. The signal intensity increases as the groove width increases, but there is a limitation since the track pitch between recording marks is fixed.

For example, a DVD recording system having a track pitch of 0.74 μm preferably has the signal intensity of 0.2 to 0.6 at a non-recorded state. Similar values are defined for DVD+RW, DVD+R, DVD-RW and DVD-R in their respective written standards. JP-A No. 2002-237096 discloses that the groove width corresponding to this value is preferably 0.17 μm to 0.30 μm at the bottom of the groove. For a high-speed optical recording medium, it is preferably 0.20 μm to 0.30 μm.

In a recording and reproducing system which employs a blue LD, the groove width is similarly defined based on the linear relationship with the beam diameter. In any case, the groove width is configured at about one half or slightly less than one half of the track pitch.

This guide groove is usually a wobble so that the recording apparatus can sample the frequency in recording. It allows an input such as address and

information necessary for recording by inverting the phase of the wobble and changing the frequency within a determined range.

Regarding the optical recording method of the present invention, the information required for recording such as write strategy and write power is input in the innermost portion of the disc, i.e. lead-in region, which is read by a recording apparatus for recording with the optimum write strategy and write power; as a result, a recording at an appropriate recording speed is performed.

### —First Protective Layer—

A material for the first protective layer is not particularly restricted, and it can be appropriately selected according to applications from heretofore known materials. Examples thereof include a oxide of Si, Zn, In, Mg, Al, Ti and Zr; a nitride of Si, Ge, Al, Ti, B and Zr; a sulfide of Zn and Ta; a carbide of Si, Ta, B, W, Ti and Zr; diamond-like carbon; and a mixture thereof. Among these, a mixture of ZnS and SiO₂ with a molar ratio close to 7/3 to 8/2 is preferable. Especially for the first protective layer which is located between the recording layer and the substrate and subject to heat damages caused by thermal expansion, high temperature and changes in a room temperature, (ZnS)₈₀(SiO₂)₂₀ on a molar basis is preferable since the optical constants, thermal expansion coefficients and modulus of elasticity are optimized for this composition. It is also possible to use different materials in a laminated form.

The thickness of the first protective layer largely affects the reflectivity, modulation and recording sensitivity. It is preferable that the first protective layer has a thickness such that the reflectivity of the disc shows its local minimum value with regard to the thickness of the lower protective layer since it enhances the recording sensitivity. The thickness of the first protective layer having (ZnS)₈₀(SiO₂)₂₀ (% by mole) is preferably 40 nm to 80 nm for favorable signal characteristics with respect to a recording and reproducing wavelength for DVD, 20 nm to 50 nm for Blu-ray Disc and 30 nm to 60 nm for HD DVD. When the thickness of the first protective layer is below these ranges, the excess heat may damage to the substrate and alter the groove shape. When the thickness is above these ranges, the disc reflectivity becomes high, reducing the sensitivity.

### —Second Protective Layer—

The material for the first protective layer may also be used for the second protective layer according to applications. Examples thereof include an oxide of Si, Zn, In, Mg, Al, Ti and Zr; a nitride of Si, Ge, Al, Ti, B and Zr; a sulfide of Zn and Ta; a carbide of Si, Ta, B, W, Ti and Zr; diamond-like carbon; and a mixture thereof. The second protective layer also affects the reflectivity and the modulation, and the effect on the recording sensitivity is the most significant. Therefore, it is important to use a material having an appropriate thermal conductivity. The preferable recording sensitivity may be obtained with a mixture of ZnS and SiO₂ with a molar ratio close to 7/3 to 8/2 since the speed of heat release is reduced due to its small thermal conductivity. A material with high thermal conductivity may be selected for a high-speed recording. Example of the material with high thermal conductivity includes a material known as a transparent conductive film having In₂O₃, ZnO and SnO as the main component, a mixture thereof a material having TiO₂, Al₂O₃ and ZrO₂ as the main component and a mixture thereof. Furthermore, it is also possible to use different materials in a laminated form.

The thickness of the second protective layer is preferably 4 nm to 50 nm, and more preferably 6 nm to 20 nm. When the thickness is less than 4 nm, the light absorption rate of the recording layer decreases. The heat generated in the recording layer diffuses into the reflective layer more easily, and as a result, the recording sensitivity may significantly be reduced. When the thickness exceeds 50 nm, a crack may occur in the second protective layer.

### —Reflective Layer—

As a material for the reflective layer, metals such as Al, Au, Ag and Cu and an alloy thereof as a main component are preferable. Examples of an additional element in alloying include Bi, In, Cr, Ti, Si, Cu, Ag, Pd and Ta.

The reflective layer reflects the light in recording and reproducing to enhance the light use efficiency as well as assumes a role as a heat-releasing layer to release the heat generated in recording. For a case of a single-layer optical recording medium or a case where a recording in a double-layer optical recording takes place in a recording layer medium at the rear side from the incoming direction of the light, the reflective layer preferably has a thickness of 70 nm or greater in terms of light use efficiency and sufficient cooling speed. However, the light use efficiency and the cooling speed saturate above a certain thickness. When the reflective layer is too thick, the substrate may warp, or the films may come off due to the film stress. Hence, the thickness is preferably 300 nm or less.

The reflective layer in the front side from the incoming light of a double-layer recording medium should have a reduced thickness since it must transmit the light, and the thickness is preferably 5 nm to 15 nm. This is, however, a favorable recording cannot be preformed due to degraded heat releasing properties. Therefore, a heat-releasing layer described hereinafter is used.

### —Interfacial Layer—

Between the phase-change recording layer and the first protective layer or between the phase-change recording layer and the second protective layer, an interfacial layer including a material such as oxide, nitride and carbide which is different from that used as the first protective layer or the second protective layer may be allocated. Thus, the optical properties and thermal properties are mainly adjusted in the first protective layer or the second protective layer, and the crystallization speed is mainly adjusted in the interfacial layer.

The interfacial layer preferably has an oxide including at least Ge or Si. When the layer having an oxide including Ge or Si is adjoining the phase-change recording layer 3, the range of recording speed for favorable re-writing may be widened.

The function of the oxide including Ge or Si varies with the degree of oxidization. A favorable rewriting may be achieved at a high speed when the oxide is saturated with oxygen, including GeO₂ and SiO₂, for example. A favorable re-writing may be achieved at a lower speed when the oxide is undersaturated with oxygen, including GeO and SiO, for example, and further including non-oxidized elements such as Ge and Si. The reason for the difference in the function is still unclear, but it is assumed that the oxide saturated with oxygen has a function to promote the nucleation of the phase-change recording layer 3 and that the oxide undersaturated with oxygen conversely has a function to suppress the nucleation in the recording layer.

The interfacial layer with a different degree of oxidization may be obtained by sputtering a target in an ordinary Ar atmosphere, where the target is formed with a mixture of GeO₂ and Ge or a mixture of SiO₂ and Si having a mixing ratio which produces a desired composition, or by sputtering Ge or Si as a target in an atmosphere of a mixture of Ar gas and O₂ gas with varying the ratio of the gas flow rates.

Since it is considered controlling the nucleation, the oxide including Ge and Si exerts its effect by adjoining the phase-change recording layer 3. The phase-change recording layer 3 heated by the irradiation of a laser beam cools down from the side of the second protective layer 4 having the reflective layer 5, and the nucleation mainly occurs on the side of the second protective layer 4. Therefore, the interfacial layer is more effective when it is allocated on the side of the second protective layer 4.

The interfacial layer preferably has a thickness of 2 nm or greater since a uniform layer cannot be formed and the function is not stable with the thickness of less than 1 nm. The maximum thickness is determined usually based on the balance between the optical properties and the thermal properties; in general, it is preferably 10 nm or less.

### —Heat-Releasing Layer—

The heat-releasing layer is installed between the reflective layer and the intermediate layer to ensure the radiation and to adjust the reflectivity when a recording is performed in the front recording layer from the incoming light of the double-layer optical recording medium. Example of the material for the heat releasing layer includes a material known as a transparent conductive film having In₂O₃, ZnO and SnO as the main component, a mixture thereof, a material having TiO₂, Al₂O₃ and ZrO₂ as the main component and a mixture thereof. Depending on the composition of the recording layer, the radiation property may not be important. In that case, a mixture of ZnS and SiO₂, which is often used as a protective film, may be used.

The heat-releasing layer has a thickness of preferably 10 nm to 150 nm, and more preferably 20 nm to 80 nm. When the thickness is less than 10 nm, it may not sufficiently function as a heat-releasing layer or an optical adjustment layer. When it exceeds 150 nm, the substrate may warp, or the films may come off due to the film stress.

### Anti-Sulfuration Layer

When the reflective layer includes Ag or an Ag alloy and the second protective layer includes a film with S such as mixture of ZnS and SiO₂, an anti-sulfuration layer is installed between the second protective layer and the reflective layer to prevent the defect caused by sulfuration of the reflective layer during storage.

Examples of a material for the anti-sulfuration layer include Si, SiC, TiC, TiO₂ and a mixture of TiC and YiO₂. A uniform film is not formed, and the anti-sulfuration function is impaired unless the thickness of the anti-sulfuration layer is 1 nm or greater. Therefore, the anti-sulfuration layer preferably has a thickness of 2 nm or greater. The maximum thickness is determined usually based on the balance between the optical properties and the thermal properties; in general, it is preferably 10 nm or less for favorable re-writing performance.

### —Intermediate Layer—

The intermediate layer is allocated for separating each layer in a double-layer optical recording medium, and it is formed with a transparent resin layer having a thickness of 50 μm for DVD and HD DVD, and 25 μm for Blu-ray Disc.

### —Cover Layer—

A cover layer in a Blu-ray Disc is a layer which allows an incidence and transmission of a light. A cover layer is formed with a transparent resin layer having a thickness of 100 μm for a single-layer optical recording medium, and a 75 μm for a double-layer optical recording medium.

The layers described above are sequentially formed on the substrate by sputtering. Then, an organic protective film is formed and bonded, or a cover layer is formed. After an initialization process, an optical recording layer is produced.

The initialization is a process where a laser beam of 1×(several tens to several hundreds) μm having an intensity of 1 W to 2 W is scanned and irradiated to crystallize the recording layer which was in an amorphous state right after film deposition.

The present invention will be illustrated in more detail with reference to examples given below, but these are not to be construed as limiting the present invention.

The value of jitter σ/T_{w} is used as an indication for favorable recording properties in Examples A-1 to A-25 and Comparative Examples A-1 to A-6. The specification of jitter is 9% or less for DVD+RW and 6.5% or less for Blu-ray Disc. Therefore, it was considered that favorable re-writing performance was obtained when the jitter satisfied these standards or was close to these specifications.

### EXAMPLES A-1 TO A-9 AND COMPARATIVE EXAMPLES A-1 TO A-6

A disc substrate made of a polycarbonate resin having a diameter of 12 cm, a thickness of 0.6 mm and a groove with a track pitch of 0.74 μm was dehydrated at a high temperature. On the substrate, a first protective layer, a recording layer, a second protective layer, an anti-sulfuration layer and a reflective layer were sequentially deposited in this order, and a phase change optical recording medium was prepared.

More specifically, with a sputtering apparatus, DVD Sprinter manufactured by Unaxis, Ltd., a first protective layer having a thickness of 65 nm was deposited with a ZnS—SiO₂ target having a molar ratio of 8 to 2 was deposited on the substrate. On the first protective layer, a recording layer having a thickness of 16 nm was deposited with an alloy target having a composition on an atom basis shown in Table 1 under sputtering conditions of argon gas pressure of 0.4 Pa (3×10⁻³ Torr) and RF power of 300 mW. On the recording layer, a second protective layer having a thickness of 10 nm was deposited in the same manner as the first protective layer with a ZnS—SiO₂ target. Moreover, an anti-sulfuration layer having TiC and TiO₂ with a mass ratio of 7 to 3 and an Ag reflective layer having a thickness of 200 nm were laminated. Then, on the reflective layer, an acrylic ultraviolet-curing resin (SD318 manufactured by Dainippon Ink and Chemicals Incorporated) was applied with the spin-coating method such that the film had a thickness of 5 gm to 10 μm, which underwent ultraviolet curing to form an organic protective layer. Next, on the organic protective layer, a dummy substrate, which is equivalent to the disc substrate, made of a polycarbonate resin having a diameter of 12 cm, a thickness of 0.6 mm was laminated. Thus, phase-change optical recording media for Examples A-1 to A-9 and Comparative Examples A-1 to A-6 were prepared.

Next, each optical recording medium was crystallized for initialization by means of a large-diameter LD.

A recording was performed on each obtained optical recording medium at a recording speed of 18 m/s (about 5.15×-speed) and 10×-speed (about 35 m/s) with EFM+ modulation method. Recording and reproducing were performed using a DVD evaluation system (DDU-1000, manufactured by Pulstec Industrial Co., Ltd.) having an optical pick-up with a wavelength of 659 nm and an object lens with a numerical aperture NA of 0.65 in accordance with the standard recording and reproducing procedure of a DVD system.

The 2T write strategy was used for recording at 18 m/s, and the 1T, 2T and block write strategies were employed for recording at 10×-speed.

The write strategy shown in FIG. 8 was applied to the 2T write strategy. More specifically, the pulse width values Tₘₚ and T₃ were 0.55T and 0.725T, respectively, at the low speed, and 0.625T and 0.8125T, respectively, at the high speed, where T denotes the reference clock period. The pulse delay quantities dT₃, T_{d1}, T_{d2} and T_{d3} as well as the off-pulse widths T_{off3} and T_{off} were optimized and determined for each optical recording medium. The value of τ_{w}/(τ_{w}/τ_{b}) for forming a mark having a length of 4T or greater was maintained at 0.35 or less. Regarding the write power, P_{b} was fixed at 0.1 mW, and P_{w} and Pₑ were determined such that the jitter for each optical recording medium was its minimum.

Regarding the 1T write strategy, a strategy in which the number of pulses is n−1 for a mark having a length of n, as shown in FIG. 7A, was applied only to the high-speed recording. The width of the leading heating pulse was set at 0.7T, the width of the other pulses was set at 0.5T, and the last off-pulse was optimized for the smallest jitter. These configurations were used for each optical recording medium. As a result, the value of τ_{w}/(τ_{w}+τ_{b}) was 0.5 to 0.8 for all the media. Regarding the write power, P_{b} was fixed at 0.1 mW, and P_{w} and Pₑ were determined such that the jitter for each optical recording medium was its minimum.

The strategy shown in FIG. 10 was employed as the block write strategy. A pattern used for a 3T mark was a flat pulse, and a pattern for 4T mark to 14T mark is a pulse with a depression. The pulse width of a 3T mark is 2T, and for a pattern for recording a mark of 4T or greater, Tₜₒₚ and Tₗₚ were set at 1.2T and 0.8T, respectively, and the total pulse width was set at [(3T pulse length)+(n−3)], where n is the length of each mark. The write power values were determined as follows. Pₑ was fixed at 5 mW. The conditions for P_{w} were determined such that the width of a recording mark was saturated or 90% of the saturation, which was evaluated based on the modulation. Then, Pₕ was optimized for the smallest jitter, and Pₑ was optimized. It was possible to use the off-pulse of P_{b} indicated by a dotted line in FIG. 10, but it was not used in this test.

A reproducing was performed at a speed of 3.5 m/s with a reproducing power of 0.7 mW The jitter, the standard deviation a of the edge portion of each mark normalized by the reference window width T_{w}(σ/T_{w}), the modulation ((Rₘₐₓ−Rₘᵢₙ)/Rₘₐₓ with Rₘₐₓ representing the maximum reflectivity of a recording mark, and Rₘᵢₙ representing the minimum reflectivity of a recording mark) and the reflectivity of an erased portion were evaluated. The results are shown in Table 1.

TABLE 1

| | | | | 18 m/s | | | 10x-speed (approx. 35 m/s) | | | |
|---|---|---|---|---|---|---|---|---|---|---|
| | Recording Layer | Reflectivity | | P_{w} | Pₑ | σ/Tw | P_{w} | Pₑ | σ/T_{w} | Modulation |
| | Composition | R | Strategy | (mW) | (mW) | (%) | (mW) | (mW) | (%) | M |
| Example A-1 | (In₁₈Sb₈₂)₉₅Zn₅ | 0.27 | 1T | — | — | — | 33 | 8.0 | 8.5 | 0.55 |
| Example A-2 | | | Block | — | — | — | 26 | 7.4 | 8.7 | 0.54 |
| Comparative | | | 2T | 29 | 5.6 | 7.9 | 25 | 7.6 | 12.0 | 0.63 |
| Example A-1 | | | | | | | | | | |
| Example A-3 | (In₁₈Sb₈₂)₉₅Ge₅ | 0.25 | 1T | — | — | — | 34 | 8.4 | 8.7 | 0.57 |
| Example A-4 | | | Block | — | — | — | 26.5 | 8.0 | 9.0 | 0.58 |
| Comparative | | | 2T | 30 | 6.4 | 7.6 | 26 | 8.0 | 11.7 | 0.64 |
| Example A-2 | | | | | | | | | | |
| Example A-5 | (In₁₈Sb₈₂)₉₄Zn₃Ge₃ | 0.26 | 1T | — | — | — | 34 | 8.2 | 9.0 | 0.53 |
| Example A-6 | | | Block | — | — | — | 26 | 7.8 | 9.2 | 0.54 |
| Comparative | | | 2T | 30 | 6.0 | 7.5 | 26 | 8.0 | 13 | 0.64 |
| Example A-3 | | | | | | | | | | |
| Example A-7 | (In₁₈Sb₈₂)₉₅Ge₅ | 0.28 | Block | — | — | — | 28 | 6.2 | 9.1 | 0.58 |
| Comparative | | | 2T | 35 | 7.0 | 13.2 | — | — | — | — |
| Example A-4 | | | | | | | | | | |
| Example A-8 | (In₂₄Sb₇₆)₉₅Ge₅ | 0.23 | 1T | — | — | — | 30 | 7.8 | 10.0 | 0.57 |
| Comparative | | | 2T | 27 | 6.4 | 7.5 | — | — | — | — |
| Example A-5 | | | | | | | | | | |
| Example A-9 | (In₁₆Sb₈₄)₉₂Zn₈ | 0.23 | 1T | — | — | — | 28 | 6.8 | 10.0 | 0.58 |
| Comparative | | | 2T | 26 | 6.0 | 7.8 | — | — | — | — |
| Example A-6 | | | | | | | | | | |

The results in Table 1 indicates that the recordings at 18 m/s favorably resulted in the jitter of less than 8% except for Example A-7 although the value of τ_{w}/(τ_{w}+τ_{b}) for forming a mark with a length of 4T or greater was 0.35 or less. Example A-7 encountered many occurrences of abnormal re-crystallization, and the jitter could not be reduced. Regarding 10×-speed recordings, the modulation was less than 0.60, and the jitter was less than 10% for the cases of the 1T write strategy and the block write strategy with τ_{w}/(τ_{w}+τ_{b}) of 0.50 or greater. The jitter in Example A-7 was less than 10% since the occurrence condition for abnormal re-crystallization was not easily created.

However, Comparative Examples A-1 to A-6 showed that the modulation exceeded 0.60 when the 2T write strategy was used with the value of τ_{w}/(τ_{w}+τ_{b}) of 0.35 or less and that the jitter could not be adjusted to 10% or less.

### EXAMPLE A-10

On the phase-change optical recording media prepared in Examples A-1 to A-4, high-speed recordings were performed at 12×-speed (about 42 m/s) with the 1T write strategy shown in FIG. 7A, and the width of the recording marks were monitored. Here, the pattern of the 1T write strategy and the reproducing conditions were equivalent to those in Example 1.

It was found that the modulation exceeded 0.45 when the write power was 30 mW or greater and that the width of a recording mark was about 75% of the 0.28-μm groove. The reflectivity was 0.25, and the R×M exceeded 0.11. The jitter was 10%.

From the conditions above, the write power was increased. When the write power was 36 mW, the jitter was 9.3%, reflectivity was 0.25 and R×M was 0.14. The width of a recording mark was about 90% of the groove width.

The write power was further increased. When the write power was 39 mW, the mark width was almost equivalent to or a little less than the groove width. The mark didn't spread even though the write power was further increased. At this point, the modulation was 0.59, and the jitter was 9.8%.

### EXAMPLE A-11

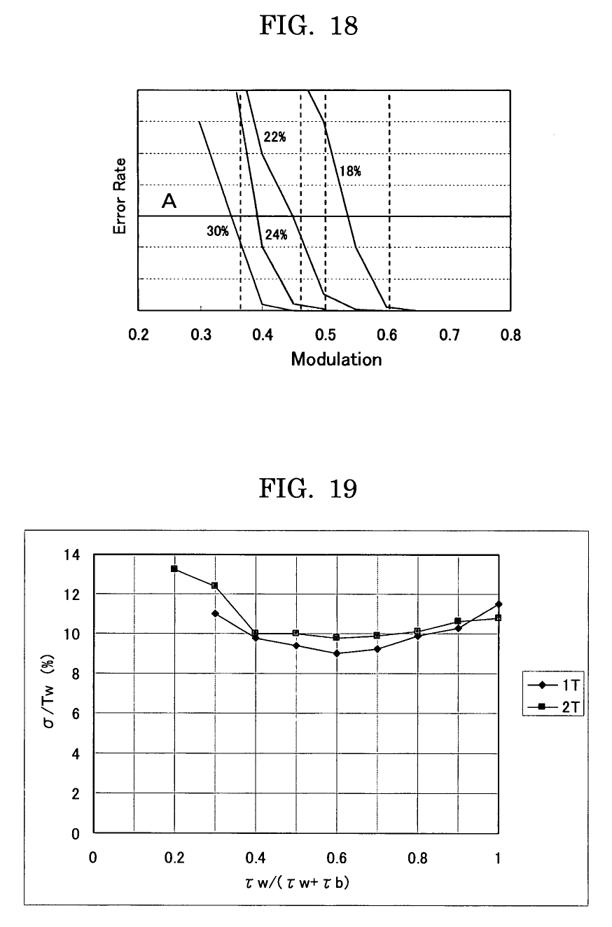

Optical recording media were prepared in the same manner as Example 1 except that the thicknesses of the recording layers and the first protective layers were adjusted such that the reflectivity of the media were 18%, 22%, 24% and 30%, respectively. For each optical recording medium, a recording was performed at 6×-speed with the 2T write strategy, and the modulation was adjusted by varying the write power. Furthermore, the error rate in reproducing was evaluated. The results are shown in FIG. 18.

The results in FIG. 18 indicate that the modulation decreases with decreasing write power. The vertical dotted line in FIG. 18 indicates the modulation, i.e. 0.6, 0.5, 0.46 and 0.37, for the reflectivity of 18%, 22%, 24% and 30%, respectively, with which the value of R×M is 0.11.

The results in FIG. 18 also indicate that the error rates abruptly increased when the value of R×M was near 0.11. When the modulation was small, the error rate started increasing with the modulation greater than 0.11. However, an error rate lower than the level of the correction ability of DVD indicated by the horizontal solid line A was obtained with the modulation with which the value of R M was 0.11.

Therefore, even though the modulation M is small, a recording system which can stand ordinary use may be achieved given that the reflectivity is high.

### EXAMPLES A-12 TO A-18 AND COMPARATIVE EXAMPLES A-7 TO A-13

On a substrate made of a polycarbonate resin having a diameter of 12 cm, a thickness of 0.6 mm and a groove with a track pitch of 0.74 μm, a first protective layer having a thickness of 60 nm was deposited with a ZnS—SiO₂ target having a molar ratio of 8 to 2 with a sputtering apparatus, DVD Sprinter manufactured by Unaxis, Ltd. On the first protective layer, a recording layer having a thickness of 14 nm and a composition shown in Table 2 was deposited by co-sputtering, using a multi source of In₂₀Sb₈₀, Ge, Zn and Te while controlling the power. On the recording layer, a second protective layer having a thickness of 6 nm and ZnS—SiO₂ with a molar ratio of 8 to 2, an anti-sulfuration layer having TiC and TiO₂ with a mass ratio of 7 to 3 and an Ag reflective layer having a thickness of 200 nm were laminated by the sputter. Then, an organic protective layer (SD318 manufactured by Dainippon Ink and Chemicals Incorporated) was applied with the spin-coating method, and a dummy substrate having a thickness of 0.6 mm was laminated. Thus, phase-change optical recording media for Examples A-12 to A-18 and Comparative Examples A-7 to A-13 were prepared.

Next, each optical recording medium was crystallized for initialization by means of a large-diameter LD.

For each optical recording medium, the transition linear velocity and the recording performance were evaluated using a DVD evaluation system (DDU-1000, manufactured by Pulstec Industrial Co., Ltd.) having an optical pick-up with a wavelength of 660 nm and an object lens with a numerical aperture NA of 0.65. The results are shown in Table 2. Each optical recording medium had a different transition linear velocity depending on the types and quantities of the elements in the recording layer. The transition linear velocity was the value measured with a surface power of 15 mW. A random pattern consisting of 3T to 14T was recorded with EFM+ modulation method on each optical recording medium 10 times at a recording speed of 8×-speed (about 28 m/s), 10×-speed (about 35 m/s) and 12×-speed (about 42 m/s).

In Table 2, ‘OK’ indicates the case where the jitter ((σ/T_{w}) was 10% or below; ‘NG’, otherwise.

Recordings at 8×-speed were performed such that the modulation M was 0.60 or greater. For recordings at 10×-speed and 12×-speed, the cases with the modulation M of greater than 0.60 and of less 0.60 were separately evaluated. The 2T write strategy was used for the recording at 8×-speed to 12×-speed with the modulation greater than 0.60, and the recordings were performed with a multi pulse having the width of the heating pulse of 0.6T and the width of the cooling pulse of 1.4T while the locations and the widths of the leading pulse and the trailing pulse as well as the powers were optimized. The value of τ_{w}/(τ_{w}+τ_{b}) for forming a mark having a length of 4T or greater was 0.35 or less.

The 1T write strategy was used for recordings at 10×-speed and 12×-speed with the modulation M of 0.60 or less, and recordings were performed with a multi pulse having the having the width of the multi pulse of 0.55T and the width of the cooling pulse of 0.45T while the locations and the widths of the leading pulse and the trailing pulse as well as the powers were optimized. The value of τ_{w}/(τ_{w}+τ_{b}) for forming a mark having a length of 4T or greater was 0.50 to 0.8. Also, for all the recording conditions, the value of the optimized power Pₑ/P_{w} was in the range of 0.23 to 0.33.

TABLE 2

| | | Transition | | | | | | | |
|---|---|---|---|---|---|---|---|---|---|
| | Recording Layer | Linear Velocity | Reflectivity | 8x-Speed | 10x-Speed | | 12x-Speed | | |
| | (% by atom) | (m/s) | R | M > 0.60 | M > 0.60 | M ≦ 0.60 | M > 0.60 | M ≦ 0.60 | Rx M |
| Example A-12 | In₁₉Sb₇₄Zn₇ | 18 | 0.24 | — | — | OK | — | NG | 0.118 |
| Comparative | | | | NG | NG | — | NG | — | — |
| Example A-7 | | | | | | | | | |
| Example A-13 | In₁₉Sb₇₅Zn₃Ge₃ | 20 | 0.25 | — | — | OK | — | NG | 0.129 |
| Comparative | | | | NG | NG | — | NG | — | — |
| Example A-8 | | | | | | | | | |
| Example A-14 | In₁₉Sb₇₅Ge₆ | 21 | 0.26 | — | — | OK | — | NG | 0.141 |
| Comparative | | | | OK | NG | — | NG | — | — |
| Example A-9 | | | | | | | | | |
| Example A-15 | In₁₉Sb₇₇Zn₂Ge₂ | 26 | 0.29 | — | — | OK | — | OK | 0.138 |
| Comparative | | | | OK | OK | — | NG | — | — |
| Example A-10 | | | | | | | | | |
| Example A-16 | In₁₉Sb₇₇Zn₄ | 30 | 0.28 | — | — | OK | — | OK | 0.132 |
| Comparative | | | | OK | OK | — | NG | — | — |
| Example A-11 | | | | | | | | | |
| Example A-17 | In₁₉Sb₇₆Te₅ | 31 | 0.25 | — | — | OK | — | OK | 0.124 |
| Comparative | | | | NG | OK | — | OK | — | — |
| Example A-12 | | | | | | | | | |
| Example A-18 | In₂₀Sb₈₀ | 34 | 0.27 | — | — | NG | — | OK | 0.130 |
| Comparative | | | | NG | NG | — | OK | — | — |
| Example A-13 | | | | | | | | | |

In the results in Table 2, the value of R×M denotes the product of the reflectivity R of the each optical recording medium and the modulation M with which the jitter was 10% or less in a recording at 10×-speed or 12×-speed and the modulation M was 0.60 or less. The modulation in any case was 0.4 or greater.

When re-writings were performed at a linear velocity greater by 5 m/s to 18 m/s than the transition linear velocity, favorable re-writing performance couldn't be obtained due to the degrading jitter under the condition of M>0.60, but a favorable re-writing performance was obtained under the condition of M≦0.60. In particular, re-writing in the optical recording media of Examples A-14 to A-16 was possible at 8×-speed under the same conditions as those for recording in a 8×-speed optical recording medium, and favorable re-writing performance was obtained by recording under the condition of M≦0.60 even at a high speed such as 10×-speed and 12×-speed.

In addition, it was examined whether favorable re-writing performance was obtained with the optical recording medium of Example A-15 by optimizing the recording method for the modulation M of less than 0.4. The re-writing performance after 10 re-writings was the most favorable with the jitter of 12.8% and the modulation of 0.38.

### EXAMPLE A-19

With the optical recording medium of Example A-15, recordings were performed at 12×-speed while the width of the heating pulse for 1T and 2T were varied. FIG. 19 shows the relation between the value of τ_{w}/(τ_{w}+τb) and the jitter (σ/T_{w}) after 10 recordings, where τ_{w} denotes the irradiation period of the heating pulse, τ_{b} denotes the irradiation period of the cooling pulse. To obtain these results, the powers were adjusted to maintain the modulation below 0.50, and the length and location of the leading pulse and the trailing pulse were optimized so that the jitter was reduced. When the value of τ_{w}/(τ_{w}+τ_{b}) was 0.4 to 0.8, the jitter was about 10% or less for both 1T and 2T.

### EXAMPLE A-20

A 12×-speed recording was performed with a long pulse on the optical recording medium of Example A-15. The pulse waveform shown in FIG. 13 was used, while Pₕ's added to the front and rear was both P_{w}+5 mW with a length of 0.5T, and the cooling pulse was 0.2 mW with a length of 0.5T. The pulse length, location and power of P_{w} were optimized. The most favorable re-writing performance was obtained when P_{w}=19 mW and Pₑ=8.6 mW. The jitter was 9.2%, and the modulation was 0.48 after 10 re-writings.

### EXAMPLE A-21

The optimum range of Pₑ/P_{w} for 8×-speed, 10×-speed and 12×-speed were examined with the optical recording media of Examples A-12 to A-18. The 2T write strategy was used for 8×-speed and 10×-speed. The 2T write strategy and the block write strategy shown in FIG. 13 were used for 12×-speed.

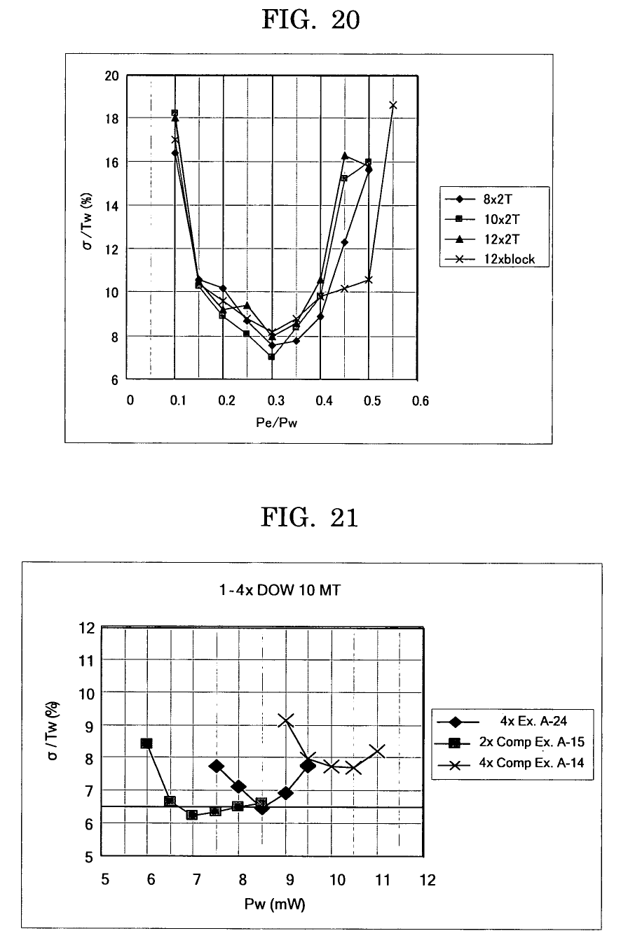

FIG. 20 shows the lowest values of jitter after 10 re-writings. When the value of Pₑ/P_{w} was less than 0.15, the jitter abruptly increased for all the cases, and a favorable re-writing was not achieved. The jitter was generally favorable after the initial recording, but a residual of an amorphous mark remained in rewriting because of small Pₑ, and this was considered as the reason for the degraded jitter. The jitter abruptly increased when the value of Pₑ/P_{w} was 0.40 or greater for the 2T write strategy and 0.50 or greater for the block write strategy. For these cases, the jitter degraded even after the initial writing.

### EXAMPLE A-22

An optical recording medium of Example A-22 was prepared in the same manner as Examples A-12 to A-18 except that the composition of the recording layer was changed to Ga₇Sb₆₇Sn₂₀Ge₆.

On the obtained optical recording medium, a recording was performed at 12×-speed with the 1T write strategy. The values of P_{w}, Pₑ and τ_{w}/(τ_{w}+τ_{b}) were 32 mW, 8 mW and 0.5 to 0.8, respectively. Also, the reflectivity was 0.305, and the transition linear velocity was 30 m/s. Favorable re-writing performance after 10 re-writings was achieved with the modulation of 0.6 or greater and the jitter of 9% or less for 8×-speed. Having optimized the re-writing conditions for 12×-speed, the most Gfavorable re-writing performance after 10 re-writings was achieved with the jitter of 9.5% and the modulation of 0.54.

### EXAMPLE A-23

An optical recording medium of Example A-23 was prepared in the same manner as Examples A-12 to A-18 except that the composition of the recording layer was changed to Te₁₉Sb₇₄Ge₅In₂.

On the obtained optical recording medium, a recording was performed at 8×-speed with the 1T write strategy. The reflectivity was 0.21, and the transition linear velocity was 14 m/s. Having optimized the re-writing conditions for 8×-speed (28 m/s), the re-writing performance after 10 re-writings was the most favorable with the jitter of 9.9% and the modulation of 0.45 when the values of P_{w}, Pₑ and τ_{w}/(τ_{w}+τ_{b}) were 28 mW, 7 mW and 0.45, respectively.

### EXAMPLE A-24 AND COMPARATIVE EXAMPLES A-14 TO A-15

On a substrate made of a polycarbonate resin having a diameter of 12 cm, a thickness of 1.1 mm and a groove with a track pitch of 0.32 μm, a reflective layer with Ag and 5% by mass of Bi having a thickness of 140 nm, a second protective layer 4 with ZnO and 3% by mass of Al₂O₃ having a thickness of 8 nm and a recording layer 3 with a multi source of In₂₀Sb₈₀, Ge, Zn and Te having a thickness of 11 nm were deposited by co-sputtering with a sputtering apparatus (DVD Sprinter manufactured by Unaxis Limited) while controlling the power for desired composition. Furthermore, a first protective layer 2 having a thickness of 33 nm and having ZnS and SiO₂ with a molar ratio of 8 to 2 was deposited. A bonding material composed of an ultraviolet curing resin was applied with the spin-coating method, and a polycarbonate film having a thickness of 0.75 μm manufactured by Teijin Limited was laminated to form a cover layer. Thus, phase-change optical recording media for Examples A-24 and Comparative Examples A-14 to A-15 were prepared.

Next, each optical recording medium was crystallized for initialization by means of a large-diameter LD.

For each optical recording medium, the transition linear velocity and the recording performance were evaluated using a Blu-ray Disc evaluation system (ODU-1000, manufactured by Pulstec Industrial Co., Ltd.) having an optical pick-up with a wavelength of 405 nm and an object lens with a numerical aperture NA of 0.85. The transition linear velocity measured with a continuous light of 5 mW was 17 m/s.

A recording was performed with 17PP modulation method, a reference speed (1×-speed) of 4.92 m/s, the shortest mark length of 0.149 μm and a recording density equivalent to the recording capacity of 25 GB. A random pattern consisting of 2T to 8T was recorded in three consecutive tracks for 10 times. The middle track was reproduced at 1×-speed, and the modulation and the jitter after limit equalization were evaluated.

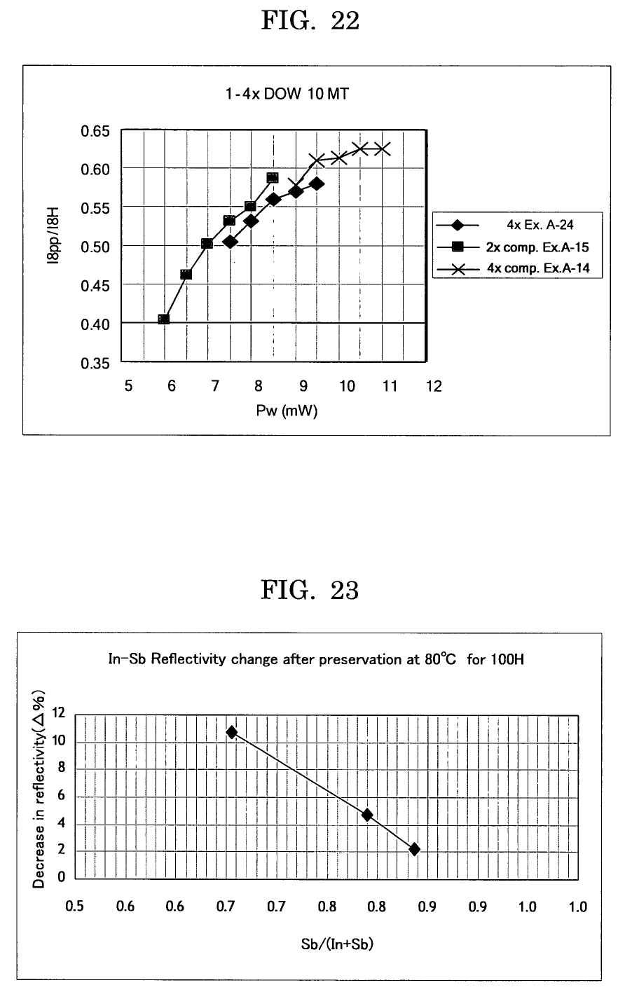

The recording conditions are shown in Table 3. The value of P_{b} was fixed at 0.1 mW for all the cases. The value of τ_{w}/(τ_{w}+τ_{b}) is the condition for recording marks of 4T to 8T. For Example A-24, a mark of 2T to 3T was recorded with a single pulse of P_{w} and without cooling before transition to Pₑ. For Comparative Example A-15, a mark of 2T to 3T was recorded with a single pulse of P_{w} and with a cooling pulse which reduces the power level to P_{b} before transition to Pₑ. FIGS. 21 and 22 show the relation between the jitter and the modulation.

TABLE 3

| | Recording speed | Pₑ/P_{w} | τ_{w}/(τ_{w} + τₕ) |
|---|---|---|---|
| Example A-24 | 4x-speed | 0.33 | 0.54 to 0.69 |
| Comparative | 4x-speed | 0.34 | 0.32 to 0.42 |
| Example A-14 | | | |
| Comparative | 2x-speed | 0.4 | 0.32 to 0.42 |
| Example A-15 | | | |

The results in Table 3 and FIGS. 21 and 22 indicate that a favorable recording was performed at 4×-speed (19.68 m/s) in Example A-24 while the jitter was not reduced nor the modulation was increased in Comparative Example A-14. However, as it can be observed in Comparative Example A-15, a favorable recording may be performed at 2×-speed (9.84 m/s) even though the value of τ_{w}/(τ_{w}+τ_{b}) was the same as that for Comparative Example A-14. Here, in Comparative Example A-14 and Comparative Example A-15, the value of τ_{w}/(τ_{w}+τ_{b}) was 0.42 under the recording condition of 5T among 4T to 8T, and the value of τ_{w}/(τ_{w}+τ_{b}) was less than 0.4 under all the other recording conditions.

### EXAMPLE A-25 AND COMPARATIVE EXAMPLE A-16

Optical recording media of Example A-25 and Comparative Example A-16 were prepared in the same manner as Example A-23 except that the recording layer with a thickness of 11 nm was formed with an alloy target of Ge₁₃Sb_{67.5}Sn₁₅Mn_{4.5} and that the second protective layer with a thickness of 8 nm was formed with a target of (ZrO₂—Y₂O₃ (3% by mole))-TiO₂ (20% by mole). The optical recording media were evaluated also in the same manner as Example A-23. Table 4 shows the results of the jitter and modulation after 10 re-writings at 4×-speed with the 2T write strategy.

TABLE 4

| | P_{w} | Pₑ | | σ/Tw | Modulation |
|---|---|---|---|---|---|
| | (mW) | (mW) | τ_{w}/(τ_{w} + τₕ) | (%) | M |
| Example A-25 | 8.5 | 2.6 | 0.54 to 0.69 | 7.4 | 0.53 |
| Comparative | 9.5 | 3.0 | 0.32 to 0.42 | 8.2 | 0.61 |
| Example A-16 | | | | | |

The results in Table 4 indicate that the jitter increased by a little less than 1% when the value of τ_{w}/(τ_{w}/τ_{b}) was small in Comparative Example A-16 compared to Example A-25 with the large τ_{w}/(τ_{w}+τ_{b}). Here, in Comparative Example A-16, the value of τ_{w}/(τ_{w}+τ_{b}) was 0.42 under the recording condition of 5T among 4T to 8T, and the value of τ_{w}/(τ_{w}+τ_{b}) was less than 0.4 under all the other recording conditions.

### EXAMPLES B-1 TO B-6 AND COMPARATIVE EXAMPLES B-1 TO B-4

An optical recording medium having a layer composition compliant with the phase-change optical recording medium of the present invention shown as a schematic cross-sectional diagram in FIG. 16 was prepared.

That is, on a substrate (transparent resin 1) made of a polycarbonate resin having a diameter of 12 cm, a thickness of 0.6 mm and a groove with a track pitch of 0.74 μm, a first protective layer 2, a phase-change recording layer 3, a second protective layer 4, an anti-sulfuration layer (not shown) and a reflective layer 5 were formed by the sputtering method. This was then over-coated with an organic protective layer 6, and another polycarbonate disc substrate was laminated. Thus, optical recording media of Examples B-1 to B-6 and Comparative Examples B-1 to B-5 were prepared.

More specifically, on the polycarbonate substrate, a first protective layer 2 having a thickness of 60 nm with ZnS and SiO₂ having a molar ratio of 8 to 2 was deposited. Then, a phase-change recording layer 3 having a thickness of 14 nm and an In—Sb—Zn composition shown in Table 5 below was deposited. Then, a second protective layer 4 having a thickness of 6 nm with ZnS and SiO₂ having a molar ratio of 8 to 2 was deposited. Moreover, an anti-sulfuration layer having TiC and TiO₂ with a mass ratio of 7 to 3 having a thickness of 4 nm and an Ag reflective layer having a thickness of 200 nm were laminated. This was over-coated with an organic protective layer, and another polycarbonate disc was bonded by adhesion. Next, each optical recording medium was crystallized for initialization by means of a large-diameter LD and used for the evaluation below.

Comparative Examples B-1 to B-4 show examples of optical recording media in which the In—Sb—Zn composition of the phase change recording layer was beyond the range specified by the present invention. Table 5 below shows the composition of the phase-change recording layer.

### <Evaluation>

For each optical recording medium prepared as above, the transition linear velocity and the jitter (σ/T_{w}) were measured with using a DVD evaluation system (DDU-1000, manufactured by Pulstec Industrial Co., Ltd.) having an optical pick-up with a wavelength of 660 nm and an object lens with a numerical aperture NA of 0.65. The power for measuring the transition linear velocity was set at 15 mW. Also, the jitter (σ/T_{w}) was the value after 10 re-writings of a random pattern with EFM+modulation method at 6×-speed and 12×-speed of DVD.

The recording was performed only in one track. The recording for each case was performed with the 2T write strategy, in which the pulse period for forming an amorphous mark was 2T, while the write power and the pulse width were respectively optimized. The results are shown in Table 5.

TABLE 5

| | Recording Layer | | | Transition | | | |
|---|---|---|---|---|---|---|---|
| | Composition | | | Linear | | | |
| | (% by atom) | | | Velocity | σ/T_{w} (%) | | |
| | In | Sb | Zn | (m/s) | 6x-speed | 12x-speed | Remarks |
| Example B-1 | 16 | 82 | 2 | 32 | 10.8 | 8.9 | |
| Example B-2 | 15 | 81 | 4 | 31 | 10.2 | 8.7 | |
| Example B-3 | 15 | 80 | 5 | 26 | 9.5 | 8.8 | |
| Example B-4 | 13 | 80 | 7 | 22 | 8.4 | 10.3 | |
| Example B-5 | 16 | 77 | 7 | 18 | 7.9 | 11.2 | |
| Example B-6 | 13 | 77 | 10 | 14 | 8.7 | 12.6 | |
| Comparative | 29 | 70 | 1 | 26 | 9.4 | 10.5 | Large decrease in |
| Example B-1 | | | | | | | reflectivity after |
| | | | | | | | storage |
| Comparative | 8 | 90 | 2 | 32 | 14.4 | 15.2 | Small modulation |
| Example B-2 | | | | | | | |
| Comparative | 22 | 78 | 0 | 30 | 12.3 | 11.6 | |
| Example B-3 | | | | | | | |
| Comparative | 10 | 79 | 11 | 12 | 12.6 | 16.8 | |
| Example B-4 | | | | | | | |

The results in Table 5 indicate that very favorable recordings were performed for Examples B-1 to B-6 with the jitter (σ/T_{w}) of 9% or less at any one of 6×-speed and 12×-speed. Also, a preservation test was performed at a temperature of 80° C. and a relative humidity of 85% for 100 hours in Examples B-1 to B-6, and the results for all the cases were favorable with the increase in the jitter (σ/T_{w}) of a recorded mark was 1% or less and the decrease in the reflectivity of a non-recorded portion was 6% or less.

On the other hand, Comparative Example B-1 is the case where the ratio of Sb/(In+Sb) was below the range of the present invention. The results were not very poor regarding the jitter (σ/T_{w}) that it was around 10% for both 6×-speed and 12×-speed. However, the decrease in the reflectivity after storage was about 10%, and there was a problem in the crystalline stability.

Comparative Example B-2 is the case where the ratio of Sb/(In+Sb) was above the range of the present invention. The modulation was around 40% even though the strategy and the power were optimized. Also, the jitter (σ/T_{w}) was large.

Comparative Example B-3 is the case where Zn was not included in the composition of the recording layer. The jitter after the initial recording was favorable, but the jitter after re-writings could not be reduced to 11% or less.

Comparative Example B-4 is the case where the composition of Zn was too high. The non-uniformity in the initialization was severe, and the jitter was largely increased.

### EXAMPLES B-7 TO B-8 AND COMPARATIVE EXAMPLES B-5 TO B-6

Optical recording media of Examples B-7 to B-8 and Comparative Examples B-5 to B-6 were prepared in the same manner as Example B-1 except that the thicknesses of the constituting layers were changed as shown in Table 6 below. The media were evaluated for the transition linear velocity and the rewriting performance at 6×-speed and 12×-speed of DVD under the same conditions as Example B-1. The results are shown in Table 6.

Comparative Examples B-5 to B-6 show examples of optical recording media in which the transition linear velocity was beyond the range specified by the present invention due to the changes in the thickness of the layers.

TABLE 6

| | Thickness (nm) | | | | | Transition | | | |
|---|---|---|---|---|---|---|---|---|---|
| | First | | Second | Anti- | | Linear | | | |
| | Protective | Recording | Protective | Sulfuration | Reflective | Velocity | σ/T_{w} (%) | | |
| | Layer | Layer | Layer | Layer | Layer | (m/s) | 6x-speed | 12x-speed | Remarks |
| Example B-7 | 60 | 14 | 6 | 4 | 280 | 30 | 10.2 | 8.8 | |
| Example B-8 | 60 | 18 | 6 | 4 | 240 | 34 | 11.1 | 8.6 | |
| Comparative | 60 | 16 | 6 | 4 | 100 | 36 | 15.6 | 12.7 | Small |
| Example B-5 | | | | | | | | | modulation |
| Comparative | 60 | 5 | 6 | 4 | 200 | 3 | 19 | 22 | |
| Example B-6 | | | | | | | | | |

The results in Table 6 indicate that favorable recordings were performed in Examples B-7 to B-8 with the jitter (σ/T_{w}) of 9% or less at 12×-speed.

Also, a preservation test was performed at a temperature of 80° C. and a relative humidity of 85% for 100 hours in Examples B-7 to B-8, and the results for all the cases were favorable with the increase in the jitter (σ/T_{w}) of a recorded mark was 1% or less and the decrease in the reflectivity of a non-recorded portion was 6% or less.

On the other hand, Comparative Examples B-5 to B-6 showed large values of the jitter (σ/T_{w}) at both 6×-speed and 12×-speed. A recording at 1×-speed was also tried in Comparative Example B-6, but the jitter after 10 re-writings was 13%.

### EXAMPLES B-9 TO B-11 AND COMPARATIVE EXAMPLE B-7

Optical recording media of Examples B-9 to B-11 and Comparative Example B-7 were prepared in the same manner as Example B-1 except that Sb as a composition of the phase-change optical recording layer was partially substituted with Sn and that the compositions were changed as shown in Table 7 below. The media were evaluated for the transition linear velocity and the re-writing performance at 6×-speed and 12×-speed of DVD under the same conditions as Example B-1. The results are shown in Table 7.

Comparative Example B-7 shows an example of an optical recording medium in which the composition of Sn was beyond the range specified by the present invention.

TABLE 7

| | Recording Layer | | | | Transition | | | |
|---|---|---|---|---|---|---|---|---|
| | Composition | | | | Linear | | | |
| | (% by atom) | | | | Velocity | σ/T_{w} (%) | | |
| | In | Sb | Sn | Zn | (m/s) | 6x-speed | 12x-speed | Remarks |
| Example B-9 | 13 | 78 | 2 | 7 | 23 | 8.6 | 10.0 | |
| Example B-10 | 13 | 70 | 10 | 7 | 26 | 9.8 | 9.2 | |
| Example B-11 | 13 | 60 | 20 | 7 | 33 | 10.5 | 9.0 | |
| Comparative | 13 | 58 | 22 | 7 | 34 | 13.8 | 12.6 | Small |
| Example B-7 | | | | | | | | modulation |

The results in Table 7 indicate that favorable recordings were performed for Examples B-9 to B-11 with the jitter (σ/T_{w}) of 9% or less or near 9% at any of 6×-speed and 12×-speed.

Also, a preservation test was performed at a temperature of 80° C. and a relative humidity of 85% for 100 hours in Examples B-9 to B-11, and the results for all the cases were favorable with the increase in the jitter (σ/T_{w}) of a recorded mark was 1% or less and the decrease in the reflectivity of a non-recorded portion was 6% or less.

On the other hand, Comparative Example B-7 showed the large jitter (σ/T_{w}) for both 6×-speed and 12×-speed because of the composition of Sn beyond the range specified by the present invention.

### EXAMPLE B-12

An optical recording medium of Example B-12 was prepared in the same manner as Example B-1 except that the second protective layer of Example B-1 was replaced by an interfacial layer and a second protective layer as shown below.

### —Formation of Second Protective Layer and Interfacial Layer—

On the recording layer 3, an interfacial layer of Ge and O having a thickness of 2 nm was formed by the sputtering method with a target as a mixture of GeO₂ and Ge having a molar ratio of 1 to 1. On the interfacial layer, a second protective layer having a thickness of 4 nm and having ZnS and SiO₂ with a molar ratio of 8 to 2 was formed by the sputtering method.

Next, the prepared optical recording medium was evaluated for the transition linear velocity and the re-writing performance at 6×-speed and 12×-speed under the same conditions as Example B-1.

Favorable results were obtained that the transition linear velocity was 28 m/s and that the jitter (σ/T_{w}) after 10 re-writings was 8.9% at 6×-speed and 9.2% at 12×-speed.

Also, a preservation test was performed at a temperature of 80° C. and a relative humidity of 85% for 100 hours, and the results were favorable with the increase in the jitter (σ/T_{w}) of a recorded mark was 1% or less and the decrease in the reflectivity of a non-recorded portion was 3% or less.

### EXAMPLE B-13

An optical recording medium of Example B-13 was prepared in the same manner as Example B-5 except that the second protective layer of Example B-5 was replaced by an interfacial layer and a second protective layer as shown below.

### —Formation of Second Protective Layer and Interfacial Layer—

On the recording layer 3, an interfacial layer of SiO₂ having a thickness of 2 nm was formed by the sputtering method with a target of SiO₂. On the interfacial layer, a second protective layer having a thickness of 4 nm and having ZnS and SiO₂ with a molar ratio of 8 to 2 was formed by the sputtering method.

Next, the prepared optical recording medium was evaluated for the transition linear velocity and the re-writing performance at 6×-speed and 12×-speed under the same condition as Example B-5.

Favorable results were obtained that the transition linear velocity was 24 m/s and that the jitter (σ/T_{w}) after 10 re-writings was 8.5% at 6×-speed and 9.6% at 12×-speed.

Also, a preservation test was performed at a temperature of 80° C. and a relative humidity of 85% for 100 hours, and the results were favorable with the increase in the jitter (σ/T_{w}) of a recorded mark was 1% or less and the decrease in the reflectivity of a non-recorded portion was 3% or less.

### EXAMPLE B-14

An optical recording medium of Example B-14 was prepared by laminating: a mixture of ZnS and SiO₂ having a molar ratio of 8 to 2 as a first protective layer with a thickness of 60 nm; the same material as that in Example B-3 as a phase-change recording layer with a thickness of 14 nm; a mixture of ZnO and 2% by mass of Al₂O₃ as a second protective layer with a thickness of 11 nm; and Ag as a reflective layer with a thickness of 200 nm.

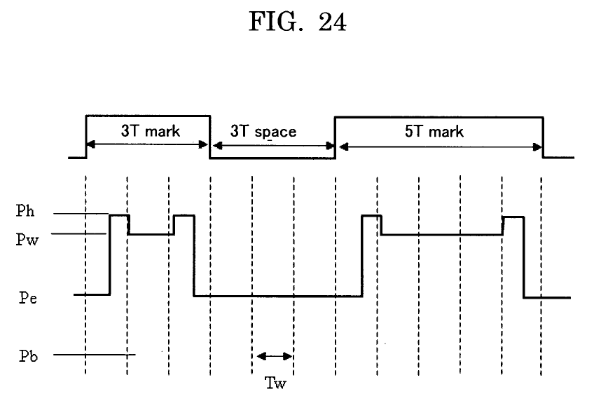

On the obtained optical recording medium, re-writings were performed at 16×-speed with the write strategy shown in FIG. 24 with no cooling pulse in the mark formation process. The jitter after 10 re-writings was 10.9%, and the transition linear velocity was 35 m/s.

Also, a preservation test was performed at a temperature of 80° C. and a relative humidity of 85% for 100 hours, and the results were favorable with the increase in the jitter of a recorded mark was 1% or less and the decrease in the reflectivity of a non-recorded portion was 4% or less.

### EXAMPLES B-15 TO B-18

An optical recording medium having a layer composition compliant with the phase-change optical recording medium of the present invention shown as a schematic cross-sectional diagram in FIG. 17 was prepared. That is, on a polycarbonate disc substrate 1 having a diameter of 12 cm, a thickness of 1.1 mm and a groove with a track pitch of 0.0.32 μm, a reflective layer 5, a second protective layer 4, a phase-change recording layer 3 and a first protective layer 2 were formed by the sputtering method, and a cover layer 7 having a thickness of 0.1 mm was formed.

More specifically, on the polycarbonate disc substrate 1, the following layers were formed: a reflective layer of Ag and 5% by mass of Bi having a thickness of 140 μm; a second protective layer 4 of ZnO and 2% by mass of Al₂O₃ having a thickness of 8 nm; a phase-change recording layer 3 of a composition shown in Table 5 below having a thickness of 11 nm; and a first protective layer 2 of a mixture of ZnS and SiO₂ with a molar ratio of 8 to 2 having a thickness of 33 nm. Then, an adhesive of an ultraviolet curing resin was applied by the spin-coating method so that the adhesive layer had a thickness of 25 μm. On this, a polycarbonate film having a thickness of 75 μm was laminated to form a cover layer 7. The obtained optical recording media were crystallized for initialization by means of a large-diameter LD and used for the evaluation below.

### <Evaluation>

For each optical recording medium prepared as above, the transition linear velocity and the jitter (σ/T_{w}) were evaluated with using a Blu-ray Disc evaluation system (ODU-1000, manufactured by Pulstec Industrial Co., Ltd.) having an optical pick-up with a wavelength of 405 nm and an object lens with a numerical aperture NA of 0.85. The power for measuring the transition linear velocity was set at 5 mW. Here, the jitter (σ/T_{w}) was the value after reproducing at 1×-speed (4.92 m/s) and using an limit equalizer, which is the value after re-writings of a random pattern with 17PP modulation method at 2×-speed and 4×-speed of Blu-ray Disc.

The recording was performed only in one track. The recording for each sample was performed with 2T write strategy, where the pulse period for forming an amorphous mark was 2T while the write power and the pulse width were optimized, respectively. The results are shown in Table 8.

Also, a preservation test was performed at a temperature of 80° C. and a relative humidity of 85% for 100 hours in Examples B-15 to B-18, and the results for all the cases were favorable with the increase in the jitter (σ/T_{w}) of a recorded mark was 0.5% or less and the decrease in the reflectivity of a non-recorded portion was 5% or less.

TABLE 8

| | Recording Layer | | | | Transition | | |
|---|---|---|---|---|---|---|---|
| | Composition | | | | Linear | | |
| | (% by atom) | | | | Velocity | σ/T_{w} (%) | |
| | In | Sb | Sn | Zn | (m/s) | 6x-speed | 12x-speed |
| Example B-15 | 17 | 76 | 0 | 7 | 15 | 5.1 | 7.6 |
| Example B-16 | 17 | 74 | 2 | 7 | 16 | 5.2 | 6.3 |
| Example B-17 | 17 | 66 | 10 | 7 | 21 | 5.9 | 6.2 |
| Example B-18 | 17 | 56 | 20 | 7 | 24 | 6.0 | 6.8 |

The results in Table 8 indicate that favorable recordings were performed in Examples B-15 to B-18 with the jitter (σ/T_{w}) of 6% or less at 2×-speed and 7% or less at 4×-speed except for Example B-15.

### COMPARATIVE EXAMPLE B-8

An optical recording medium of Comparative Example B-8 was prepared in the same manner as Example B-17 except that the thickness of the phase change recording layer was changed to 5 nm while maintaining the same composition (In₁₇Sb₆₆Sn₁₀Zn₇) as that of Example B-17.

Then, the obtained optical recording medium was evaluated in the same manner as Examples B-15 to B-18. The transition linear velocity was 4 m/s, and the jitter (σ/T_{w}) was 15% or greater at both 2×-speed and 4×-speed. Also, the jitter (σ/T_{w}) was 10% or greater even when the recording was performed at 1×-speed.

### COMPARATIVE EXAMPLE B-9

An optical recording medium of Comparative Example B-9 was prepared in the same manner as Examples B-15 to B-18 except that the composition of the recording layer was changed to In₁₄Sb₈₃Zn₃.

Then, the obtained optical recording medium was evaluated in the same manner as Examples B-15 to B-18. The transition linear velocity was 37 m/s. The modulation was small, and the jitter (σ/T_{w}) was 15% or greater at both 2×-speed and 4×-speed. Also, the modulation was small even when the recording was at 6×-speed, and the jitter (σ/T_{w}) was 15% or greater.

### INDUSTRIAL APPLICABILITY

The optical recording medium of the present invention may be favorably applied to an optical recording medium having a phase-change recording layer which enables a high-density recording such as DVD+RW, DVD-RW, BD-RE and HD DVD RW.

1. An optical recording method comprising the steps of:
irradiating a light on an optical recording medium which comprises a substrate with a guide groove and a phase-change recording layer on the substrate; and
recording a mark of an amorphous phase and a space of a crystal phase on the phase-change recording layer, corresponding to any one of the salient portion or the depressed portion of the groove as viewed from the incoming direction of the light,
wherein information is recorded by means of a mark length recording method, having the temporal length of the mark and the space expressed as nT, wherein T denotes a reference clock period, and n denotes a natural number;
wherein the space is formed at least by an erase pulse irradiating power Pₑ;
wherein all the marks having a length of 4T or greater are formed by a multi pulse alternatively irradiating a heating pulse of power P_{w} and a cooling pulse of power P_{b} while P_{w}>P_{b}; and
wherein the Pₑ and the P_{w} satisfy the following equations:
0.15≦Pₑ/P_{w}≦0.4, and
0.4≦τ_{w}/(τ_{w}+τ_{b})≦0.8,
wherein τ_{w} denotes the sum of the length of the heating pulses, and τ_{b} denotes the sum of the length of the cooling pulses.

2. (canceled)

3. The optical recording method according to claim 1,
wherein a recording is performed at 10×-speed with respect to the reference speed or greater when a recording and reproducing is performed with a laser beam having a wavelength of 640 nm to 660 nm, and
wherein a recording is performed at 4×-speed with respect to the reference speed or greater when a recording and reproducing is performed with a laser beam having a wavelength of 400 nm to 410 nm.

4. The optical recording method according to claim 1, wherein a recording is performed such that the average of the minimum distance between marks on two adjacent tracks in the radial direction is greater than the half of the track pitch.

5. The optical recording method according to claim 1, wherein the modulation M of the longest mark satisfies the following equation:
0.35≦M≦0.60.

6-11. (canceled)

12. An optical recording medium used in an optical recording method,
wherein the optical recording method comprises the steps of:
irradiating a light on an optical recording medium which comprises a substrate with a guide groove and a phase-change recording layer on the substrate; and
recording a mark of an amorphous phase and a space of a crystal phase on the phase-change recording layer, corresponding to any one of the salient portion or the depressed portion of the groove as viewed from the incoming direction of the light,
wherein information is recorded by means of a mark length recording method, having the temporal length of the mark and the space expressed as nT, wherein T denotes a reference clock period, and n denotes a natural number;
wherein the space is formed at least by an erase pulse irradiating power Pₑ;
wherein all the marks having a length of 4T or greater are formed by a multi pulse alternatively irradiating a heating pulse of power P_{w} and a cooling pulse of power P_{b} while P_{w}>P_{b}; and
wherein the Pₑ and the P_{w} satisfy the following equations:
0.15≦Pₑ/P_{w}≦0.4, and
0.4≦τ_{w}/(τ_{w}+τ_{b})≦0.8,
wherein τ_{w} denotes the sum of the length of the heating pulses, and τ_{b} denotes the sum of the length of the cooling pulses; and
wherein information related to the optical recording method is recorded in advance on the substrate of the optical recording medium.

13. An optical recording method comprising the steps of:
irradiating a light on an optical recording medium which comprises a substrate with a guide groove and a phase-change recording layer on the substrate; and
recording a mark of an amorphous phase and a space of a crystal phase on the phase-change recording layer, corresponding to any one of the salient portion or the depressed portion of the groove as viewed from the incoming direction of the light, wherein information is recorded by means of a mark length recording method, with the temporal length of the mark and the space expressed as nT, wherein T denotes a reference clock period, and n denotes a natural number;
wherein the space is formed at least by an erase pulse irradiating power P_{c}, and the mark is formed by irradiating a heating pulse of power P_{w}, while P_{w}>P_{b}; and
wherein the P_{c} and the P_{w} satisfy the following equation: 0.15≦P_{c}/P_{w}≦0.5.

14. The optical recording method according to claim 13,
wherein a recording is performed at 10×-speed with respect to the reference speed or greater when a recording and reproducing is performed with a laser beam having a wavelength of 640 nm to 660 nm, and
wherein a recording is performed at 4×-speed with respect to the reference speed or greater when a recording and reproducing is performed with a laser beam having a wavelength of 400 nm to 410 nm.

15. The optical recording method according to claim 13, wherein a recording is performed such that the average of the minimum distance between marks on two adjacent tracks in the radial direction is greater than the half of the track pitch.

16. The optical recording method according to claim 13, wherein the modulation M of the longest mark satisfies the following equation: 0.35≦M≦0.60.

17. An optical recording medium used in an optical recording method,
wherein the optical recording method comprises the steps of:
irradiating a light on an optical recording medium which comprises a substrate with a guide groove and a phase-change recording layer on the substrate; and
recording a mark of an amorphous phase and a space of a crystal phase on the phase-change recording layer, corresponding to any one of the salient portion or the depressed portion of the groove as viewed from the incoming direction of the light,
wherein information is recorded by means of a mark length recording method, with the temporal length of the mark and the space expressed as nT, wherein T denotes a reference clock period, and n denotes a natural number;
wherein the space is formed at least by an erase pulse irradiating power Pₑ, and the mark is formed by irradiating a heating pulse of power P_{w}, while P_{w}>P_{b}; and
wherein the Pₑ and the P_{w} satisfy the following equation: 0.15≦Pₑ/P_{w}≦0.5; and
wherein information related to the optical recording method is recorded in advance on the substrate of the optical recording medium.

18. An optical recording medium comprising:
a substrate with a guide groove; and
a phase-change recording layer on the substrate,
wherein the rotational linear velocity of the optical recording medium is a variable, and the transition linear velocity corresponding to the point at which the reflectivity measured by the irradiation of a continuous light with a pick-up head on the optical recording medium starts to decrease is 5 m/s to 35 m/s; and
wherein the phase-change recording layer comprises a phase-change material expressed by Composition Formula (1) below:
(Sb₁₀₀₋ₓIn)_{100-y}Zn_{y} Composition Formula (1)
wherein, in Composition Formula (1), x and y denote the percentage of respective elements by atom; 10% by atom ≦x≦27% by atom; and 1% by atom ≦y≦10% by atom.

19. The optical recording medium according to claim 18, wherein the optical recording medium comprises: the substrate with a guide groove; a first protective layer; the phase-change recording layer; a second protective layer; and a reflective layer, in the order mentioned from the direction of the incoming light.

20. The optical recording medium according to claim 18, wherein the phase-change recording layer has a thickness of 6 nm to 22 nm.

21. The optical recording medium according to claim 18,
wherein the optical recording medium comprises: an interfacial layer any one of between the phase-change recording layer and the first protective layer and between the phase-change recording layer, and the second protective layer; and
wherein the interfacial layer comprises an oxide of any one of Ge and Si.

22. An optical recording medium comprising:
a substrate with a guide groove; and
a phase-change recording layer on the substrate,
wherein the rotational linear velocity of the optical recording medium is a variable, and the transition linear velocity corresponding to the point at which the reflectivity measured by the irradiation of a continuous light with a pick-up head on the optical recording medium starts to decrease is 5 m/s to 35 m/s, and
wherein the phase-change recording layer comprises a phase-change material expressed by Composition Formula (2) below:
[(Sb_{100-z}Sn_{z})₁₀₀₋ₓIn]_{100-y}Zn_{y} Composition Formula (2)
wherein, in Composition Formula (2), x, y and z denote the percentage of respective elements by atom; 0% by atom ≦z≦25% by atom; 10% by atom ≦x≦27% by atom; and 1% by atom ≦y≦10% by atom.

23. The optical recording medium according to claim 22, wherein the optical recording medium comprises: the substrate with a guide groove; a first protective layer; the phase-change recording layer; a second protective layer; and a reflective layer, in the order mentioned from the direction of the incoming light.

24. The optical recording medium according to claim 22, wherein the phase-change recording layer has a thickness of 6 nm to 22 nm.

25. The optical recording medium according to claim 22,
wherein the optical recording medium comprises: an interfacial layer any one of between the phase-change recording layer and the first protective layer and between the phase-change recording layer, and the second protective layer; and
wherein the interfacial layer comprises an oxide of any one of Ge and Si.
